(19) United States
(12) Patent Application Publication
(10) Pub. No.: US 2026/0143503 A1
(43) Pub. Date: May 21, 2026

(54) UPDATING PAGING PARAMETERS USING DOWNLINK CONTROL INFORMATION

(71) Applicant: Lenovo (United States) Inc., Morrisville, NC (US)

(72) Inventors: Alexander Golitschek Edler von Elbwart, Darmstadt (DE); Prateek Basu Mallick, Dreieich (DE); Joachim Löhr, Wiesbaden (DE)

(73) Assignee: Lenovo (United States) Inc., Morrisville, NC (US)

(21) Appl. No.: 18/949,680

(22) Filed: Nov. 15, 2024

(51) Int. Cl. H04W 72/232; H04W 68/02

(52) U.S. Cl. CPC H04W 72/232; H04W 68/02

(57) ABSTRACT

Various aspects of the present disclosure relate to updating paging parameters using downlink control information (DCI). A user equipment (UE) may receive DCI including at least one element (e.g., parameter, field, value) that indicate an update (e.g., change, adjustment) to one or more parameters of a set of parameters associated with one or more paging messages. The set of parameters may form (e.g., make up) a paging configuration. In some examples, the at least one element may include a short messages indicator of the DCI. In some other examples, the at least one element may include an element of a short messages field of the DCI. The UE may monitor for the one or more paging messages using the update to the one or more parameters.

### TECHNICAL FIELD

The present disclosure relates to wireless communications, and more specifically to paging in wireless communications.

### BACKGROUND

A wireless communications system may include one or multiple network communication devices, which may be otherwise known as network equipment (NE), supporting wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers, or the like)). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

### SUMMARY

An article “a” before an element is unrestricted and understood to refer to “at least one” of those elements or “one or more” of those elements. The terms “a,” “at least one,” “one or more,” and “at least one of one or more” may be interchangeable. As used herein, including in the claims, “or” as used in a list of items (e.g., a list of items prefaced by a phrase such as “at least one of” or “one or more of” or “one or both of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on”. Further, as used herein, including in the claims, a “set” may include one or more elements.

A UE for wireless communication is described. The UE may be configured to, capable of, or operable to perform one or more operations as described herein. For example, the UE may be configured to, capable of, or operable to receive downlink control information (DCI) including at least one element (e.g., parameter, field, value) that indicates an update to one or more parameters of a set of parameters associated with one or more paging messages; and monitor for the one or more paging messages based on the update to the one or more parameters.

A processor (e.g., a standalone processor chipset, or a component of a UE) for wireless communication is described. The processor may be configured to, capable of, or operable to perform one or more operations as described herein. For example, the processor may be configured to, capable of, or operable to receive DCI including at least one element (e.g., parameter, field, value) that indicates an update to one or more parameters of a set of parameters associated with one or more paging messages; and monitor for the one or more paging messages based on the update to the one or more parameters.

A method performed or performable by a UE for wireless communication is described. The method may include receiving DCI including at least one element (e.g., parameter, field, value) that indicates an update to one or more parameters of a set of parameters associated with one or more paging messages; and monitoring for the one or more paging messages based on the update to the one or more parameters.

In some implementations of the UE, the processor, and the method described herein, the at least one element includes a short messages indicator of the DCI, and the short messages indicator indicates one or more bits of the DCI include the update to the one or more parameters. In some implementations of the UE, the processor, and the method described herein, the at least one element includes an element of a short messages field of the DCI, and the element indicates one or more bits of the DCI include the update to the one or more parameters. In some implementations of the UE, the processor, and the method described herein, the at least one element includes a short messages indicator of the DCI, and the short messages indicator indicates one or more bits of the DCI include scheduling information for a downlink shared channel transmission including the update to the one or more parameters. In some implementations of the UE, the processor, and the method described herein, the UE, the processor, and the method may further be configured to, capable of, operable to receive the downlink shared channel transmission based on the scheduling information. In some implementations of the UE, the processor, and the method described herein, the at least one element includes a first element of a short messages field of the DCI and a second element of the short messages field of the DCI, where the first element indicates one or more bits of the DCI include the update to the one or more parameters and the second element indicates one or more bits of a scheduled downlink shared channel transmission include the update to the one or more parameters.

In some implementations of the UE, the processor, and the method described herein, the at least one element may further include a short messages indicator of the DCI, and the short messages indicator indicates that the one or more parameters are being updated. In some implementations of the UE, the processor, and the method described herein, the UE, the processor, and the method may further be configured to, capable of, operable to receive the scheduled downlink shared channel transmission based on the DCI. In some implementations of the UE, the processor, and the method described herein, the UE, the processor, and the method may further be configured to, capable of, operable to receive, prior to the DCI, signaling that indicates a set of configurations associated with paging, where a first configuration of the set of configurations includes the set of parameters associated with the one or more paging messages and where a second configuration of the set of configurations includes the update to the one or more parameters of the set of parameters associated with the one or more paging messages, and where the at least one element activates the first configuration or the second configuration. In some implementations of the UE, the processor, and the method described herein, the DCI may be associated with a group of UEs including the UE. In some implementations of the UE, the processor, and the method described herein, the DCI indicates to apply the update to the one or more parameters based on a state of the UE, where the state of the UE includes at least one of an active state, an inactive state, or an idle state.

In some implementations of the UE, the processor, and the method described herein, to monitor for the one or more paging messages, the UE, the processor, and the method may further be configured to, capable of, operable to apply the update to the one or more parameters based on timing information, where the timing information includes at least one of a start of a modification period associated with the one or more paging messages, an end of a paging cycle subsequent to the DCI, a duration after reception of the DCI, or a duration relative to a system frame number (SFN). In some implementations of the UE, the processor, and the method described herein, to receive the DCI, the UE, the processor, and the method may further be configured to, capable of, operable to receive, prior to the DCI, signaling that indicates the set of parameters associated with the one or more paging messages; and monitor, based on the set of parameters, for the DCI, where the DCI may be scrambled with a paging-radio network temporary identifier (P-RNTI). In some implementations of the UE, the processor, and the method described herein, the one or more parameters includes at least one of an updated paging cycle, a paging frame (PF) offset, a numerical quantity of paging occasions (POs) within a PF, or a radio access network (RAN) paging in an idle PO parameter.

An NE (e.g., a base station) for wireless communication is described. The NE may be configured to, capable of, or operable to perform one or more operations as described herein. For example, the NE may be configured to, capable of, or operable to transmit DCI including at least one element (e.g., parameter, field, value) that indicates an update to one or more parameters of a set of parameters associated with one or more paging messages; and transmit the one or more paging messages based on the update to the one or more parameters.

A processor (e.g., a standalone processor chipset, or a component of an NE) for wireless communication is described. The processor may be configured to, capable of, or operable to perform one or more operations as described herein. For example, the processor may be configured to, capable of, or operable to transmit DCI including at least one element (e.g., parameter, field, value) that indicates an update to one or more parameters of a set of parameters associated with one or more paging messages; and transmit the one or more paging messages based on the update to the one or more parameters.

A method performed or performable by an NE (e.g., a base station) for wireless communication is described. The method includes transmitting DCI including at least one element (e.g., parameter, field, value) that indicates an update to one or more parameters of a set of parameters associated with one or more paging messages; and transmitting the one or more paging messages based on the update to the one or more parameters.

In some implementations of the NE, the processor, and the method described herein, the at least one element includes a short messages indicator of the DCI, and the short messages indicator indicates one or more bits of the DCI include the update to the one or more parameters. In some implementations of the NE, the processor, and the method described herein, the at least one element includes an element of a short messages field of the DCI, and the element indicates one or more bits of the DCI include the update to the one or more parameters. In some implementations of the NE, the processor, and the method described herein, the at least one element includes a short messages indicator of the DCI, and the short messages indicator indicates one or more bits of the DCI include scheduling information for a downlink shared channel transmission including the update to the one or more parameters. In some implementations of the NE, the processor, and the method described herein, the NE, the processor, and the method may further be configured to, capable of, operable to transmit the downlink shared channel transmission based on the scheduling information.

In some implementations of the NE, the processor, and the method described herein, the at least one element includes a first element of a short messages field of the DCI and a second element of the short messages field of the DCI, where the first element indicates one or more bits of the DCI include the update to the one or more parameters and the second element indicates one or more bits of a scheduled downlink shared channel transmission include the update to the one or more parameters. In some implementations of the NE, the processor, and the method described herein, the at least one element may further include a short messages indicator of the DCI, and the short messages indicator indicates that the one or more parameters are being updated. In some implementations of the NE, the processor, and the method described herein, the NE, the processor, and the method may further be configured to, capable of, operable to transmit the scheduled downlink shared channel transmission based on the DCI. In some implementations of the NE, the processor, and the method described herein, the NE, the processor, and the method may further be configured to, capable of, operable to transmit, prior to the DCI, signaling that indicates a set of configurations associated with paging, where a first configuration of the set of configurations includes the set of parameters associated with the one or more paging messages and where a second configuration of the set of configurations includes the update to the one or more parameters of the set of parameters associated with the one or more paging messages, and where the at least one element activates the first configuration or the second configuration.

In some implementations of the NE, the processor, and the method described herein, the NE, the processor, and the method may further be configured to, capable of, operable to transmit, after the DCI, one or more SIBs, where the one or more SIBs includes the update to the one or more parameters. In some implementations of the NE, the processor, and the method described herein, to transmit the DCI, the NE, the processor, and the method may further be configured to, capable of, operable to transmit the DCI to a group of UEs. In some implementations of the NE, the processor, and the method described herein, the DCI indicates to apply the update to the one or more parameters based on a state of a UE, where the state of the UE includes at least one of an active state, an inactive state, or an idle state. In some implementations of the NE, the processor, and the method described herein, to transmit the DCI, the NE, the processor, and the method may further be configured to, capable of, operable to transmit, prior to the DCI, signaling that indicates the set of parameters associated with the one or more paging messages, where the DCI may be transmitted based on the set of parameters, and where the DCI may be scrambled with a P-RNTI. In some implementations of the NE, the processor, and the method described herein, the one or more parameters includes at least one of an updated paging cycle, a PF offset, a numerical quantity of POs within a PF, or a RAN paging in an idle PO parameter.

### BRIEF DESCRIPTION OF THE DRAWINGS

FIG. 1 illustrates an example of a wireless communications system in accordance with aspects of the present disclosure.

FIG. 2 illustrates an example of a downlink control channel configuration, in accordance with aspects of the present disclosure.

FIG. 3 illustrates an example of a wireless communications system in accordance with aspects of the present disclosure.

FIG. 4 illustrates an example signaling diagram, in accordance with aspects of the present disclosure.

FIG. 5 illustrates an example of a UE in accordance with aspects of the present disclosure.

FIG. 6 illustrates an example of a processor in accordance with aspects of the present disclosure.

FIG. 7 illustrates an example of an NE in accordance with aspects of the present disclosure.

FIG. 8 illustrates a flowchart of a method performed by a UE in accordance with aspects of the present disclosure.

FIG. 9 illustrates a flowchart of a method performed by an NE in accordance with aspects of the present disclosure.

### DETAILED DESCRIPTION

A wireless communications system may include one or more devices (e.g., UEs and NEs) that exchange signaling. For example, a NE transmits control signaling to a UE to configure transmission and reception of paging messages, among other information. The paging messages notify the UE of an incoming data transmission. When the UE detects a paging message addressed to the UE, the UE initiates a connection establishment procedure with the NE to receive the incoming data transmission. When the UE is not monitoring for the control signaling or the paging messages and/or when the NE is not transmitting the control signaling or the paging messages, the UE and the NE may transition to a mode that uses less power (e.g., an idle or inactive mode, also referred to as an RRC idle state or an RRC inactive state, respectively).

Thus, to save energy at the network and/or the UE side, a NE may adapt (e.g., update, modify, adjust) the paging configuration according to a numerical quantity of UEs within a coverage area of the NE, such as by adjusting a periodicity of the paging messages to be less frequent when the NE detects a lower number of UEs in the coverage area. The decrease in paging messages provides for the NE and the UE to remain in an idle or inactive mode for longer, conserving energy at the NE and the UE. In some cases, the NE transmits a DCI that notifies the UE of another message including system information (SI) (e.g., a SI block (SIB)) with an updated paging configuration, and then transmits the SIB to the UE. However, transmitting a DCI and a SIB results in multiple occurrences of the UE waking up from an idle or inactive mode to process the corresponding information in the DCI and the SIB, leading to increased power consumption and inefficient use of time-frequency resources. Further, the UE may not apply the updated paging configuration until after receiving the SIB, which increases latency by introducing a delay between the UE being notified in the DCI about the SIB with the updated paging configuration and receiving the updated paging configuration in the SIB.

As described herein, to reduce power consumption, improve resource allocation, and reduce latency at the UE, a NE may include one or more updates to a paging configuration in signaling other than an SIB. For example, the NE may transmit a DCI to the UE that indicates an update to one or more parameters in the paging configuration. The parameters in the paging configuration (e.g., the parameters to be updated) may include, but are not limited to, an updated paging cycle, a PF offset, a numerical quantity of POs within a PF, or a RAN paging in an idle PO parameter. In some cases, the DCI may include the updated values of the parameters. Additionally, or alternatively, the DCI may indicate that a scheduled downlink shared channel transmission includes the updated values of the parameters. The UE may apply the updated parameters when monitoring for paging messages from the NE, such that the UE may receive one or more paging messages from the NE according to the updated parameters.

Reference is made herein to communicating data or information between devices, such as transmission and reception of control information (SIBs, DCI, paging messages, etc.). It is to be appreciated that other terms may be used interchangeably with communicating, such as signaling, transmitting, receiving, outputting, forwarding, retrieving, obtaining, and so forth.

Aspects of the present disclosure are described in the context of a wireless communications system.

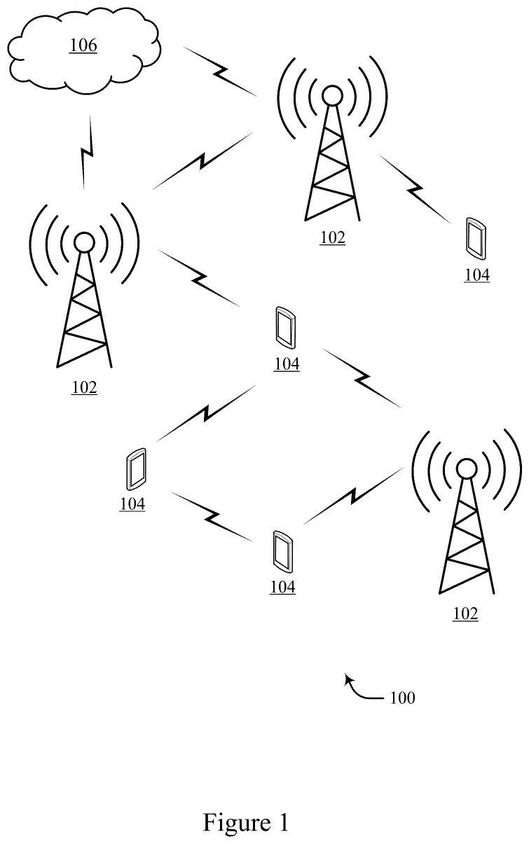

FIG. 1 illustrates an example of a wireless communications system 100 in accordance with aspects of the present disclosure. The wireless communications system 100 may include one or more NEs 102, one or more UEs 104, and a core network (CN) 106. The wireless communications system 100 may support various radio access technologies. In some implementations, the wireless communications system 100 may be a 4G network, such as an LTE network or an LTE-Advanced (LTE-A) network. In some other implementations, the wireless communications system 100 may be a NR network, such as a 5G network, a 5G-Advanced (5G-A) network, or a 5G ultrawideband (5G-UWB) network. In other implementations, the wireless communications system 100 may be a combination of a 4G network and a 5G network, or other suitable radio access technology including Institute of Electrical and Electronics Engineers (IEEE) 802.11 (Wi-Fi), IEEE 802.16 (WiMAX), IEEE 802.20. The wireless communications system 100 may support radio access technologies beyond 5G, for example, 6G. Additionally, the wireless communications system 100 may support technologies, such as time division multiple access (TDMA), frequency division multiple access (FDMA), or code division multiple access (CDMA), etc.

The one or more NEs 102 may be dispersed throughout a geographic region to form the wireless communications system 100. One or more of the NEs 102 described herein may be or include or may be referred to as a network node, a base station, an access point (AP), a network element, a network function, a network entity, a RAN, a NodeB, an eNodeB (eNB), a next-generation NodeB (gNB), or other suitable terminology. An NE 102 and a UE 104 may communicate via a communication link, which may be a wireless or wired connection. For example, an NE 102 and a UE 104 may perform wireless communication (e.g., receive signaling, transmit signaling) over a Uu interface.

An NE 102 may provide a geographic coverage area for which the NE 102 may support services for one or more UEs 104 within the geographic coverage area. For example, an NE 102 and a UE 104 may support wireless communication of signals related to services (e.g., voice, video, packet data, messaging, broadcast, etc.) according to one or multiple radio access technologies. In some implementations, an NE 102 may be moveable, for example, a satellite associated with a non-terrestrial network (NTN). In some implementations, different geographic coverage areas associated with the same or different radio access technologies may overlap, but the different geographic coverage areas may be associated with different NE 102.

The one or more UEs 104 may be dispersed throughout a geographic region of the wireless communications system 100. A UE 104 may include or may be referred to as a remote unit, a mobile device, a wireless device, a remote device, a subscriber device, a transmitter device, a receiver device, or some other suitable terminology. In some implementations, the UE 104 may be referred to as a unit, a station, a terminal, or a client, among other examples. Additionally, or alternatively, the UE 104 may be referred to as an Internet-of-Things (IoT) device, an Internet-of-Everything (IoE) device, or machine-type communication (MTC) device, among other examples.

A UE 104 may be able to support wireless communication directly with other UEs 104 over a communication link. For example, a UE 104 may support wireless communication directly with another UE 104 over a device-to-device (D2D) communication link. In some implementations, such as vehicle-to-vehicle (V2V) deployments, vehicle-to-everything (V2X) deployments, or cellular-V2X deployments, the communication link may be referred to as a sidelink. For example, a UE 104 may support wireless communication directly with another UE 104 over a PC5 interface.

An NE 102 may support communications with the CN 106, or with another NE 102, or both. For example, an NE 102 may interface with other NE 102 or the CN 106 through one or more backhaul links (e.g., S1, N2, N6, or other network interface). In some implementations, the NE 102 may communicate with each other directly. In some other implementations, the NE 102 may communicate with each other indirectly (e.g., via the CN 106). In some implementations, one or more NEs 102 may include subcomponents, such as an access network entity, which may be an example of an access node controller (ANC). An ANC may communicate with the one or more UEs 104 through one or more other access network transmission entities, which may be referred to as a radio heads, smart radio heads, or transmission-reception points (TRPs).

The CN 106 may support user authentication, access authorization, tracking, connectivity, and other access, routing, or mobility functions. The CN 106 may be an evolved packet core (EPC), or a 5G core (5GC), which may include a control plane entity that manages access and mobility (e.g., a mobility management entity (MME), an access and mobility management functions (AMF)) and a user plane entity that routes packets or interconnects to external networks (e.g., a serving gateway (S-GW), a packet data network (PDN) gateway (P-GW), or a user plane function (UPF)). In some implementations, the control plane entity may manage non-access stratum (NAS) functions, such as mobility, authentication, and bearer management (e.g., data bearers, signal bearers, etc.) for the one or more UEs 104 served by the one or more NEs 102 associated with the CN 106.

The CN 106 may communicate with a packet data network over one or more backhaul links (e.g., via an S1, N2, N6, or other network interface). The packet data network may include an application server. In some implementations, one or more UEs 104 may communicate with the application server. A UE 104 may establish a session (e.g., a protocol data unit (PDU) session, or the like) with the CN 106 via an NE 102. The CN 106 may route traffic (e.g., control information, data, and the like) between the UE 104 and the application server using the established session (e.g., the established PDU session). The PDU session may be an example of a logical connection between the UE 104 and the CN 106 (e.g., one or more network functions of the CN 106).

In the wireless communications system 100, the NEs 102 and the UEs 104 may use resources of the wireless communications system 100 (e.g., time resources (e.g., symbols, slots, subframes, frames, or the like) or frequency resources (e.g., subcarriers, carriers)) to perform various operations (e.g., wireless communications). In some implementations, the NEs 102 and the UEs 104 may support different resource structures. For example, the NEs 102 and the UEs 104 may support different frame structures. In some implementations, such as in 4G, the NEs 102 and the UEs 104 may support a single frame structure. In some other implementations, such as in 5G and among other suitable radio access technologies, the NEs 102 and the UEs 104 may support various frame structures (i.e., multiple frame structures). The NEs 102 and the UEs 104 may support various frame structures based on one or more numerologies.

One or more numerologies may be supported in the wireless communications system 100, and a numerology may include a subcarrier spacing (SCS) and a cyclic prefix. A first numerology (e.g., μ=0) may be associated with a first SCS (e.g., 15 kilohertz (kHz)) and a normal cyclic prefix. In some implementations, the first numerology (e.g., μ=0) associated with the first SCS (e.g., 15 kHz) may utilize one slot per subframe. A second numerology (e.g., μ=1) may be associated with a second SCS (e.g., 30 kHz) and a normal cyclic prefix. A third numerology (e.g., μ=2) may be associated with a third SCS (e.g., 60 kHz) and a normal cyclic prefix or an extended cyclic prefix. A fourth numerology (e.g., μ=3) may be associated with a fourth SCS (e.g., 120 kHz) and a normal cyclic prefix. A fifth numerology (e.g., μ=4) may be associated with a fifth SCS (e.g., 240 kHz) and a normal cyclic prefix.

A time interval of a resource (e.g., a communication resource) may be organized according to frames (also referred to as radio frames). Each frame may have a duration, for example, a 10 millisecond (ms) duration. In some implementations, each frame may include multiple subframes. For example, each frame may include 10 subframes, and each subframe may have a duration, for example, a 1 ms duration. In some implementations, each frame may have the same duration. In some implementations, each subframe of a frame may have the same duration.

Additionally, or alternatively, a time interval of a resource (e.g., a communication resource) may be organized according to slots. For example, a subframe may include a number (e.g., quantity) of slots. The number of slots in each subframe may also depend on the one or more numerologies supported in the wireless communications system 100. For instance, the first, second, third, fourth, fifth, sixth, and seventh numerologies (i.e., μ=0, μ=1, μ=2, μ=3, μ=4, μ=5, μ=6) associated with respective subcarrier spacings of 15 kHz, 30 kHz, 60 kHz, 120 kHz, 240 kHz, 480 kHz, and 960 kHz may utilize a single slot per subframe, two slots per subframe, four slots per subframe, eight slots per subframe, 16 slots per subframe, 32 slots per subframe, and 64 slots per subframe, respectively. Each slot may include a number (e.g., quantity) of symbols (e.g., OFDM symbols). In some implementations, the number (e.g., quantity) of slots for a subframe may depend on a numerology. For a normal cyclic prefix, a slot may include 14 symbols. For an extended cyclic prefix (e.g., applicable for 60 kHz SCS), a slot may include 12 symbols. The relationship between the number of symbols per slot, the number of slots per subframe, and the number of slots per frame for a normal cyclic prefix and an extended cyclic prefix may depend on a numerology. It should be understood that reference to a first numerology (e.g., μ=0) associated with a first SCS (e.g., 15 kHz) may be used interchangeably between subframes and slots.

In the wireless communications system 100, an electromagnetic (EM) spectrum may be split, based on frequency or wavelength, into various classes, frequency bands, frequency channels, etc. By way of example, the wireless communications system 100 may support one or multiple operating frequency bands, such as frequency range designations FR1 (410 MHZ-7.125 GHZ), FR2 (24.25 GHZ-71 GHZ), FR2-1 (24.25 GHz-52.6 GHZ), FR2-2 (52.6 GHz-71 GHz). In some implementations, the NEs 102 and the UEs 104 may perform wireless communications over one or more of the operating frequency bands. In some implementations, FR1 may be used by the NEs 102 and the UEs 104, among other equipment or devices for cellular communications traffic (e.g., control information, data). In some implementations, FR2 may be used by the NEs 102 and the UEs 104, among other equipment or devices for short-range, high data rate capabilities.

FR1 may be associated with one or multiple numerologies (e.g., at least three numerologies). For example, FR1 may be associated with a first numerology (e.g., μ=0), which includes 15 kHz SCS; a second numerology (e.g., μ=1), which includes 30 kHz SCS; and a third numerology (e.g., μ=2), which includes 60 kHz SCS. FR2 may be associated with one or multiple numerologies (e.g., at least 2 numerologies). For example, FR2 may be associated with a sixth numerology (e.g., μ=5), which includes 480 kHz SCS; and a seventh numerology (e.g., μ=7), which includes 960 kHz SCS.

The devices (e.g., the UEs 104 and the NEs 102) in the wireless communications system 100 may exchange signaling. For example, a NE 102 transmits control signaling to a UE 104 to configure transmission and reception of paging messages, among other information. The paging messages notify the UE 104 of an incoming data transmission. When the UE 104 detects a paging message addressed to the UE 104, the UE 104 initiates a connection establishment procedure with the NE 102 to receive the incoming data transmission. When the UE 104 is not monitoring for the control signaling or the paging messages and/or when the NE 102 is not transmitting the control signaling or the paging messages, the UE 104 and the NE 102 may transition to a mode that uses less power (e.g., an idle or inactive mode, also referred to as an RRC idle state or an RRC inactive state, respectively).

In some examples, the NE 102 may transmit the paging messages during one or more time-frequency resources, such as POs in a time domain. A PO is a subframe within a PF during which a NE 102 may transmit paging messages. Multiple POs may occur within a single PF. The NE 102 and/or the UE 104 may define the subframes of a PO according to one or more parameters in control signaling, such as a UE identity and a paging cycle. For example, the NE 102 may transmit control signaling that configures the UE 104 to monitor for the paging messages during the POs. The NE 102 may configure the UE 104 to monitor for paging messages using one or more SIBs. A SIB may include SI and configuration parameters that UEs 104 use to access and operate within a network. The NE 102 may transmit SIBs periodically (e.g., via a downlink broadcast channel). The NE 102 may schedule or indicate the presence of a SIB in DCI.

In some cases, DCI may include one or more different fields (e.g., parameters, messages, indicators, values). For example, the DCI may include a short messages indicator and a corresponding short messages field. A short messages indicator in DCI is a field that may indicate the presence of a short message within the DCI. A NE 102 may use a short messages indicator to indicate to one or more UEs 104 that bits in the DCI (e.g., bits in a short messages field of the DCI) include additional information. For example, the short messages indicator may include one or more bits that indicate whether a short message includes scheduling details for paging information. A short messages field may include a set of bits in the DCI that indicates a relatively small amount of data or control information, or that indicates the presence of specific data or control information.

In some examples, the NE 102 may transmit a short messages field in a downlink control channel (e.g., a physical downlink control channel (PDCCH)). The downlink control channel may include the DCI with bits allocated for the short messages field, where the DCI may be a DCI format 1_0. The NE 102 may transmit the downlink control channel with or without one or more paging messages. The NE 102 may scramble the downlink control channel and/or the DCI with a P-RNTI to indicate to the UEs 104 that the DCI is related to paging information. The short messages field may include one or more bits, according to Table 1, where the first bit is a most significant bit.

TABLE 1
Short messages definition

| Bit | Short Message |
|---|---|
| 1 | systemInfoModification |
| | If set to 1: indication of a broadcast control channel (BCCH) |
| | modification other than SIB6, SIB7, SIB8 and posSIBs. |
| 2 | etwsAndCmasIndication |
| | If set to 1: indication of an earthquake and tsunami warning |
| | system (ETWS) primary notification and/or an ETWS secondary |
| | notification and/or a commercial mobile alert Frsystem |
| | (CMAS) notification. |
| 3 | stopPagingMonitoring |
| | This bit can be used for operation with shared spectrum |
| | channel access and if nrofPDCCH-MonitoringOccasionPerSSB-InPO |
| | is present. If set to 1: indication that the UE 104 may stop |
| | monitoring PDCCH occasion(s) for paging in a PO. |
| 4 | systemInfoModification-eDRX |
| | If set to 1: indication of a BCCH modification other than |
| | SIB6, SIB7, SIB8 and posSIBs. This indication applies to |
| | UEs using an IDLE extended discontinuous reception (eDRX) |
| | cycle longer than a BCCH modification period. |
| 5-8 | Not processed by UE 104 if received. |

In some cases, a DCI may have one or more fields according to a format. For example, a DCI I format 1_0 with one or more cyclic redundance check (CRC) bits scrambled by a P-RNTI may include, but is not limited to, a short messages indicator, a short messages field, a frequency domain resource assignment, a time domain resource assignment, a virtual resource block (VRB)-to-physical resource block (PRB) mapping, a modulation and coding scheme (MCS), a transport block (TB) scaling, a tracking reference signal (TRS) availability indication, and one or more reserved bits. The short messages indicator may include two bits, where the bit values are defined according to Table 2.

TABLE 2
Short messages indicator definition

| Bit field | Short Message indicator |
|---|---|
| 00 | Reserved |
| 01 | Scheduling information for paging, and TRS |
| | availability indication if trs-ResourceSetConfig |
| | is configured, are present in the DCI |
| 10 | Short message, and TRS availability indication if |
| | trs-ResourceSetConfig is configured, are present |
| | in the DCI |
| 11 | Both scheduling information for Paging, TRS |
| | availability indication if trs-ResourceSetConfig |
| | is configured, and short message are present |
| | in the DCI |

The short messages field may include eight bits. If the scheduling information for paging, and TRS availability indication if trs-ResourceSetConfig or trs-ResourceSetConfig-r18 is configured, are carried, the short messages field is reserved. The frequency domain resource assignment may include

$$⌈ {log}_{2} ( {N}_{R B}^{D L , B W P} ( {N}_{R B}^{D L , B W P} + 1 ) / 2 ) ⌉ bits .$$

If the short message, and TRS availability indication if trs-ResourceSetConfig or trs-ResourceSetConfig-r18 is configured, are carried, the frequency domain resource assignment bit field is reserved, where

$${N}_{R B}^{D L , B W P}$$

is a size of control resource set (CORESET) 0. The time domain resource assignment may include four bits. If the short message, and TRS availability indication if trs-ResourceSetConfig or trs-ResourceSetConfig-r18 is configured, are carried, the time domain resource assignment bit field is reserved. The VRB-to-PRB mapping may be one bit. If the short message, and TRS availability indication if trs-ResourceSetConfig or trs-ResourceSetConfig-r18 is configured, are carried, the VRB-to-PRB mapping bit field is reserved. The MCS field includes five bits. If the short message, and TRS availability indication if trs-ResourceSetConfig or trs-ResourceSetConfig-r18 is configured, are carried, the MCS bit field is reserved. The TB scaling field includes two bits. If the short message, and TRS availability indication if trs-ResourceSetConfig or trs-ResourceSetConfig-r18 is configured, are carried, the TB scaling bit field is reserved. The TRS availability indication may include different numerical quantities (e.g., numbers) of bits, such as one bit, two bits, three bits, four bits, five bits, or six bits. The numerical quantity of bits is equal to one plus the highest value of the indBitID(s) provided by the trs-ResourceSetConfig if configured or the number of bits is equal to one plus the highest value of all the indBitID)-r18(s) provided by the trs-ResourceSetConfig-r18 if configured; 0 bits otherwise. The reserved bits may include (8-M) bits for operation in a cell with shared spectrum channel access in frequency range 1 (FR1) or for operation in a cell in frequency range 2-2 (FR2-2); or (6-M) bits for operation in a cell without shared spectrum channel access, where the value of M is a numerical quantity of bits for the field of TRS availability indication.

In some examples, a NE 102 may notify the UE 104 (e.g., via control signaling) of a SI change. For example, a modification period is used (e.g., updated SI message other than SI message for ETWS, CMAS, positioning assistance data, and some non-terrestrial network (NTN)-specific information as specified in the field descriptions) is broadcasted in the modification period following the one where SI change indication is transmitted. The modification period boundaries are defined by SFN values for which SFN mod (m)=0, where m is the number of radio frames including the modification period. The modification period is configured by SI. If H-SFN is provided in SIBI, and the UE 104 is configured with eDRX, modification period boundaries are defined by SFN values for which (H-SFN*1024+SFN) mod m=0.

For UEs 104 in RRC_IDLE or RRC_INACTIVE configured to use an IDLE eDRX cycle longer than the modification period, an eDRX acquisition period is defined. The boundaries of the eDRX acquisition period are determined by H-SFN values for which H-SFN mod 1024=0. The UE 104 receives indications about SI modifications and/or public warning system (PWS) notifications using a short message transmitted with a P-RNTI over DCI. Repetitions of SI change indication may occur within a preceding modification period or within preceding eDRX acquisition period. The SI change indication may not be applicable for SI messages containing posSIBs. UEs 104 in RRC_IDLE or in RRC_INACTIVE while a small data transmission (SDT) procedure is not ongoing may monitor for an SI change indication in POs of the UEs 104 (e.g., a PO that a UE 104 monitors). UEs 104 in RRC_CONNECTED may monitor for an SI change indication in any PO at least once per modification period if the UE 104 is provided with a common search space, including pagingSearchSpace, searchSpaceSIB1 and searchSpaceOtherSystemInformation, on an active bandwidth part (BWP) to monitor paging. UEs 104 in RRC_INACTIVE while SDT procedure is ongoing may monitor for an SI change indication in any PO at least once per modification period, if the initial downlink BWP on which the SDT procedure is ongoing is associated with a cell-defining synchronization signal block (CD-SSB).

During a modification period where ETWS or CMAS transmission is started or stopped, the SI messages carrying the posSIBs scheduled in posSchedulingInfoList may change, so the UE 104 may not be able to successfully receive the posSIBs in the remainder of the current modification period and next modification period according to the scheduling information received prior to the change. ETWS or CMAS capable UEs in RRC_IDLE or in RRC_INACTIVE while SDT procedure is not ongoing may monitor for indications about PWS notification in POs that the UE 104 monitors. ETWS or CMAS capable UEs in RRC_CONNECTED may monitor for indication about PWS notification in any PO at least once every defaultPagingCycle if the UE 104 is provided with common search space, including pagingSearchSpace, searchSpaceSIB1 and searchSpaceOtherSystemInformation, on the active BWP to monitor paging. ETWS or CMAS capable UEs in RRC_INACTIVE while SDT procedure is ongoing may monitor for indication about PWS notification in any PO at least once every defaultPagingCycle, if the initial downlink BWP on which the SDT procedure is ongoing is associated with a CD-SSB. For short message reception in a PO, the UE 104 monitors the PDCCH monitoring occasion(s) for paging. A layer 2 (L2) UE-to-network (U2N) remote UE 104 may not monitor a PO for SI modifications and/or PWS notifications. The UE 104 may obtain the updated SI and SIB6, SIB7, and/or SIB8 from a connected L2 U2N relay UE 104.

If the UE 104 receives a short message, and if the UE 104 is ETWS capable or CMAS capable, the etwsAndCmasIndication bit of short messages field is set, and the UE 104 is provided with searchSpaceSIB1 and searchSpaceOtherSystemInformation on the active BWP or the initial BWP, the UE 104 may perform one or more actions. For example, the UE 104 may immediately reacquire the SIB1. Additionally, or alternatively, if the UE 104 is ETWS capable and si-SchedulingInfo includes scheduling information for SIB6, the UE 104 may acquire SIB6 immediately. Additionally, or alternatively, if the UE 104 is ETWS capable and si-SchedulingInfo includes scheduling information for SIB7, the UE 104 may acquire SIB7 immediately. Additionally, or alternatively, if the UE 104 is CMAS capable and si-SchedulingInfo includes scheduling information for SIB8, the UE 104 may acquire SIB8 immediately. If SIB1, SIB6, SIB7, or SIB8 overlap with a measurement gap, the UE 104 may determine how to immediately acquire SIB1, SIB6, SIB7, or SIB8.

If the UE 104 does not operate an IDLE eDRX cycle longer than the modification period and the systemInfoModification bit of short messages field is set, then the UE 104 applies the SI acquisition procedure from a start of a next modification period. If the UE 104 operates an IDLE eDRX cycle longer than the modification period and the systemInfoModification-eDRX bit of short messages field is set, then the UE 104 applies the SI acquisition procedure from the start of the next eDRX acquisition period boundary.

In some examples, a NE 102 may transmit one or more paging messages to UEs 104 in the wireless communications system 100. The paging message is used to notify one or more UEs of an incoming transmission. The paging messages may include or be based on an indication of a signaling radio bearer, a mode of a radio link control (RLC)-service access point (SAP) (e.g., transparent mode (TM)), a logical channel (e.g., physical control channel), and a direction (e.g., network to UE 104). The paging message may include one or more fields, as shown in Table 3.

TABLE 3
Paging message definition
PagingRecord field descriptions

accessType
Indicates whether the paging message is originated due to the protocol data unit (PDU) sessions
from a type of access.
inactiveReceptionAllowed
Indicates whether the UE 104 with a valid point-to-multipoint (PTM) configuration for a TMGI in
the PagingGroupList stays in RRC_INACTIVE to receive the corresponding MBS multicast
session.
mt-SDT
Mobile terminated SDT indication. The network includes mt-SDT indication in paging message if
the UE's inactive-RNTI (I-RNTI) is included in the paging message.
pagingRecordList
If the network includes pagingRecordList-v1700, the field includes the same number of entries,
and listed in the same order, as in pagingRecordList (e.g., without suffix). If the network includes
pagingRecordList-v1800, the field includes the same number of entries, and listed in the same
order, as in pagingRecordList (e.g., without suffix). The first element in pagingRecordList-v1700
corresponds to the first UE identity in pagingRecordList (e.g., without suffix). The second
element in pagingRecordList-v1700 corresponds to the second UE identity in pagingRecordList
(e.g., without suffix), and so on. The first element in pagingRecordList-v1800 corresponds to the
first UE identity in pagingRecordList (e.g., without suffix). The second element in
pagingRecordList-v1800 corresponds to the second UE identity in pagingRecordList (e.g.,
without suffix), and so on.
pagingCause
Indicates whether the paging message is originated due to instant messaging system (IMS) voice.
If this field is present, the field implies that the corresponding paging entry is for IMS voice. If
upper layers indicate the support of paging cause and if this field is not present but
pagingRecordList-v1700 is present, the field implies that the corresponding paging entry is for a
service other than IMS voice. Otherwise, paging cause is undetermined.
pagingGroupList
If the network includes pagingGroupList-v1800, the field includes the same number of elements,
and listed in the same order, as in pagingGroupList-r17. The first element corresponds to the first
TMGI in pagingGroupList-r17. The second element corresponds to the second TMGI in
pagingGroupList-r17, and so on.

In some cases, the NE 102 may transmit a paging configuration to one or more UEs 104. A paging configuration may include a set of parameters that indicate for the UEs 104 to monitor for one or more paging messages. For example, the set of parameters may include, but is not limited to, a paging cycle, a PF offset, a numerical quantity of POs within a PF, or a RAN paging in an idle PO parameter. The paging cycle parameter may indicate a duration and periodicity for the UEs 104 to monitor for paging messages. A PF offset may indicate a timing of a PF relative to a reference point in a system frame structure. By applying a PF offset, a NE 102 can stagger the PFs for different UEs or groups of UEs, such that not all UEs 104 are scheduled to check for paging messages concurrently. The NE 102 may calculate (e.g., obtain, determine) the PF offset based on various factors, such as an identity of a UE 104, network load, or service criterion. A RAN paging in an idle PO parameter enables a RAN to initiate paging procedures during an idle mode PO of a UE 104.

The NE 102 may transmit one or more different types of configuration messages (e.g., in control signaling) including the paging configuration. For example, the NE 102 may transmit a SIB1 that includes the paging configuration. SIB1 includes information relevant when evaluating if a UE 104 is permitted to access a cell and defines the scheduling of other SI. SIB1 also contains radio resource configuration information that is common for one or more UEs 104 and barring information applied to the unified access control. The SIB1 may include or be based on an indication of a signaling radio bearer, a mode of an RLC-SAP (e.g., TM), a logical channel (e.g., BCCH), and a direction (e.g., network to UE 104). The SIB1 may include one or more fields, as shown in Tables 4 and 5.

TABLE 4
SIB1 definition
SIB1 field descriptions

barringExemptEmergencyCall
Indicates whether the cell permits emergency bearer services for UEs that may otherwise consider the
cell as barred.
cellBarred2RxXR
Indicates whether the cell is barred for dual receiver (2Rx) extended reality (XR) UEs. The field is
ignored by UEs that are not 2Rx XR UEs. The field may be configured if the cell operates in a
frequency band where quad receiver (4Rx) antenna ports are mandated. If the field is absent on a cell
operating in a frequency band where 4Rx antenna ports may be used, then a 2Rx XR UE may treat the
cell as not barred.
cellBarredATG
Value barred means that the cell is barred for connectivity to air-to-ground (ATG). Value notBarred
means that the cell is permitted for connectivity to ATG. If not present, then the UE considers the cell
is not permitted for connectivity to ATG. The field is applicable to ATG-capable UEs.
cellBarred-eRedCap1Rx
Value barred means that the cell is barred for an extended reduced capacity (eRedCap) UE supporting
a single receiver (1Rx) branch on the selected frequency band. The field may be ignored by non-
eRedCap UEs. An eRedCap UE supporting 2Rx on the selected frequency band may ignore the field
when cellBarred-eRedCap2Rx is set to notBarred.
cellBarred-eRedCap2Rx
Value barred means that the cell may be barred for an eRedCap UE supporting 2Rx branches on the
selected frequency band. The field may be ignored by non-eRedCap UEs. An eRedCap UE supporting
1Rx on the selected frequency band may ignore the field when cellBarred-eRedCap1Rx is set to
notBarred.
cellBarredFixedVSAT
Value barred means that the cell is barred for fixed very small aperture terminal (VSAT) UEs. If not
present, then the cell may not be permitted for fixed VSAT UEs. The field may be ignored by non-
VSAT UEs.
cellBarredMobileVSAT
Value barred means that the cell may be barred for mobile VSAT UEs. If not present, then the cell is
not permitted for mobile VSAT UEs. The field may be ignored by non-VSAT UEs.
cellBarredNES
The field indicates the cell barring status for UEs supporting nes-CellDTX-DRX.
cellBarredNTN
Value barred means that the cell may be barred for connectivity to NTN. Value notBarred means that
the cell is permitted for connectivity to NTN. If not present, then the UE considers the cell is not
permitted for connectivity to NTN. The field is applicable to NTN-capable UEs.
cellBarredRedCap1Rx
Value barred means that the cell may be barred for a reduced capacity (RedCap) UE supporting 1Rx
branch on the selected frequency band. The field may be ignored by non-RedCap UEs. A RedCap UE
supporting 2Rx on the selected frequency band may ignore the field when cellBarredRedCap2Rx is set
to notBarred.
cellBarredRedCap2Rx
Value barred means that the cell may be barred for a RedCap UE supporting 2Rx branches on the
selected frequency band. The field may be ignored by non-RedCap UEs. A RedCap UE supporting 1Rx
on the selected frequency band may ignore the field when cellBarredRedCap1Rx is set to notBarred.
cellSelectionInfo
Parameters for cell selection related to the serving cell.
eCallOverIMS-Support
Indicates whether the cell supports emergence call (eCall) over IMS services. If absent, then eCall over
IMS is not supported by the network in the cell.
eDRX-PermittedIdle
The presence of the field indicates that extended DRX for CN paging is permitted in the cell for UEs in
RRC_IDLE or RRC_INACTIVE. The UE may stop using extended DRX for CN paging in RRC_IDLE
or RRC_INACTIVE if eDRX-PermittedIdle is not present.
eDRX-PermittedInactive
The presence of eDRX-PermittedInactive-r17 indicates that extended DRX cycle equal to or shorter
than 10.24 seconds (s) for RAN paging is permitted in the cell for UEs in RRC_INACTIVE. The UE
may stop using extended DRX cycle equal to or shorter than 10.24 s for RAN paging in
RRC_INACTIVE if eDRX-PermittedInactive-r17 is not present. The presence of eDRX-
PermittedInactive-r18 indicates that extended DRX cycle longer than 10.24 s for RAN paging is
permitted in the cell for UEs in RRC_INACTIVE. The UE may stop using extended DRX cycle longer
than 10.24 s for RAN paging in RRC_INACTIVE if eDRX-PermittedInactive-r18 is not present.
featurePriorities
Indicates priorities for features, such as (e)RedCap, slicing, SDT, MSG1-repetitions and MSG3-
repetitions for coverage enhancements. The priorities are used to determine which
FeatureCombinationPreambles the UE may use when a feature maps to more than one
FeatureCombinationPreambles. A lower value means a higher priority. The network does not signal
the same priority for more than one feature. The network signals a priority for features that map to at
least one FeatureCombinationPreambles.
halfDuplexRedCap-Permitted
The presence of the field indicates that the cell supports half-duplex frequency division duplexing
(FDD) (e)RedCap UEs.
hsdn-Cell
The field indicates the is a high-speed data network (HSDN) cell.
hyperSFN
Indicates hyper SFN which increments by one when the SFN wraps around. The field is excluded when
determining changes in SI (e.g., changes of hyper SFN) do not result in SI change notifications.
idleModeMeasurementsEUTRA
The field indicates that a UE that is configured for evolved universal terrestrial radio access (EUTRA)
idle and/or inactive measurements may perform the measurements while camping in the cell and report
availability of these measurements when establishing or resuming a connection in the cell. If absent,
then a UE may not perform EUTRA idle and/or inactive measurements.
idleModeMeasurementsNR
The field indicates that a UE that is configured for NR idle and/or inactive measurements may perform
the measurements while camping in the cell and report availability of these measurements when
establishing or resuming a connection in the cell. If absent, then a UE may not perform NR idle and/or
inactive measurements.
ims-EmergencySupport
Indicates whether the cell supports IMS emergency bearer services for UEs in reduced service mode. If
absent, then IMS emergency call is not supported by the network in the cell for UEs in reduced service
mode.
intraFreqReselection2RxXR
The field controls cell selection and/or reselection to intra-frequency cells for 2Rx XR UEs when the
cell is barred or treated as barred by the 2Rx XR UE. The field is ignored by all UEs that are not 2Rx
XR UEs. The field may be configured if the cell operates in a frequency band where 4Rx antenna ports
are used.
intraFreqReselection-eRedCap
Controls cell selection and/or reselection to intra-frequency cells for eRedCap UEs when the cell is
barred or treated as barred by the eRedCap UE. If not present, an eRedCap UE treats the cell as barred
(e.g., the UE considers that the cell does not support eRedCap).
intraFreqReselectionRedCap
Controls cell selection and/or reselection to intra-frequency cells for RedCap UEs when the cell is
barred or treated as barred by the RedCap UE. If not present, a RedCap UE treats the cell as barred,
(e.g., the UE considers that the cell does not support RedCap).
mobileIAB-Cell
The presence of the field indicates that the is a mobile integrated access and backhaul (IAB) cell.
mt-SDT-RSRP-Threshold
Reference signal received power (RSRP) threshold used to determine whether MT-SDT procedure can
be initiated. If the field is absent, and the field sdt-RSRP-Threshold is present, then the UE applies the
value in the field sdt-RSRP-Threshold.
musim-CapRestrictionPermitted
Indicates the UE is permitted to send the musim-CapRestrictionInd in RRCSetupComplete,
RRCResumeComplete and RRCReestablishmentComplete messages.
n3c-Support
The field indicates the support of N3C MP. If the field is present, then the UE can perform early
detection of candidate N3C relay UEs. If absent, then a UE may not perform early detection of
candidate N3C relay UEs.
ncr-Support
The field combines both the support of NCR and the cell status for NCR. If the field is present, then the
cell supports NCR and the cell is also considered as a candidate for cell (re)selection for NCR-node; if
the field is absent, then the cell does not support NCR and/or the cell is barred for NCR-node.
nonServingCellMII
Indicates whether the MBSInterestIndication message for MBS broadcast reception on a non-serving
cell is permitted to be transmitted to the serving gNB.
q-QualMin
Parameter Q_{qualmin} is applicable for a serving cell. If the field is absent, then the UE applies a (e.g.,
default) value of negative infinity for Q_{qualmin}.
q-QualMinOffset
Parameter Q_{qualminoffset}. Actual value Q_{qualminoffset} = field value [decibels (dB)]. If the field is absent, the
UE applies a (e.g., default) value of 0 dB for Q_{qualminoffset}. Affects the minimum required quality level in
the cell.
q-RxLevMin
Parameter Qᵣₓₗₑᵥₘᵢₙ is applicable for a serving cell.
q-RxLevMinOffset
Parameter Q_{rxlevminoffset}. Actual value Q_{rxlevminoffset} = field value * 2 [dB]. If absent, the UE applies a
(e.g., default) value of 0 dB for Q_{rxlevminoffset}. Affects a minimum receiver level in the cell.
q-RxLevMinSUL
Parameter Qᵣₓₗₑᵥₘᵢₙ is applicable for a serving cell.
reselectionMeasurementsNR
The field indicates that a UE that is configured for NR reselection measurements may report
availability of these measurements when establishing or resuming a connection in the cell.
sdt-BeamFailureRecoveryProhibitTimer
The value of the prohibit timer used for RACH for beam failure indication during SDT. Value ms50
corresponds to 50 milliseconds (ms), value ms100 corresponds to 100 ms, and so on.
sdt-DataVolumeThreshold
Data volume threshold used to determine whether SDT can be initiated. Value byte32 corresponds to 32
bytes, value byte 100 corresponds to 100 bytes, and so on.
sdt-LogicalChannelSR-DelayTimer
The value of logicalChannelSR-DelayTimer applied during SDT for logical channels configured with
SDT. Value in number of subframes. Value sf20 corresponds to 20 subframes, sf40 corresponds to 40
subframes, and so on. If sdt-LogicalChannelSR-DelayTimer-r18 is absent and sdt-LogicalChannelSR-
DelayTimer-r17 is present then, the UE applies the value configured in sdt-LogicalChannelSR-
DelayTimer-r17 for the field. If the field is not configured, then logicalChannelSR-DelayTimer is not
applied for SDT logical channels.
sdt-RSRP-Threshold
RSRP threshold used to determine whether SDT procedure can be initiated.
servingCellConfigCommon
Configuration of a serving cell.
t319a
Initial value of the timer T319a used for detection of SDT failure. Value ms100 corresponds to 100 ms,
value ms200 corresponds to 200 ms and so on. If t319a-r18 is absent, the UE applies the value
configured in t319a-r17.
uac-AccessCategory1-SelectionAssistanceInfo
Information used to determine whether Access Category 1 applies to the UE. If plmnCommon is
chosen, the UAC-AccessCategory1-SelectionAssistanceInfo is applicable to all the PLMNs and SNPNs
in plmn-IdentityInfoList and npn-IdentityInfoList. If individualPLMNList is chosen, the 1^{st} entry in the
list corresponds to the first network within the PLMNs and SNPNs across the plmn-IdentityList and the
npn-IdentityInfoList, the 2^{nd} entry in the list corresponds to the second network within the PLMNs and
SNPNs across the plmn-IdentityList and the npn-IdentityInfoList, and so on. If uac-AC1-
SelectAssistInfo-r16 is present, then the UE may ignore the uac-AccessCategory1-
SelectionAssistanceInfo.
uac-AC1-SelectAssistInfo
Information used to determine whether Access Category 1 applies to the UE. The first entry in the list
corresponds to the first network within the PLMNs and SNPNs across the plmn-IdentityList and npn-
IdentityInfoList, the second entry in the list corresponds to the second network within the PLMNs and
SNPNs across the plmn-IdentityList and the npn-IdentityInfoList, and so on. Value notConfigured
indicates that Access Category 1 is not configured for the corresponding PLMN and/or SNPN.
uac-BarringForCommon
Common access control parameters for each access category. Common values are used for all PLMNs
and/or SNPNs, unless overwritten by the PLMN and/or SNPN specific configuration provided in uac-
BarringPerPLMN-List. The parameters are specified by providing an index to the set of configurations
(uac-BarringInfoSetList).
ue-TimersAndConstants
Timer and constant values to be used by the UE. The cell operating as PCell always provides the field.
useFullResumeID
Indicates which resume identifier and Resume request message should be used. UE uses fullI-RNTI and
RRCResumeRequest1 if the field is present, or shortI-RNTI and RRCResumeRequest if the field is
absent.

TABLE 5
SIB definition, conditional fields

| Conditional | |
|---|---|
| Presence | Explanation |
| EDRX-RC | The field is optionally present, R, in a cell that enables |
| | eDRX-PermittedIdle, otherwise the field is absent. |
| EM-Barring | The field is optionally present, R, in a cell that supports |
| | (e)RedCap or XR UEs, otherwise the field is absent. |
| MINT | The field is optionally present, R, in a cell that provides |
| | a configuration for disaster roaming, otherwise the field |
| | is absent, R. |
| MT-SDT1 | The field is optionally present, S, in a cell that supports |
| | MT-SDT if sdt-ConfigCommon-r17 is not present, |
| | otherwise the field is absent. |
| MT-SDT2 | The field is mandatory present in a cell that supports |
| | MT-SDT if sdt-ConfigCommon-r17 is not present, |
| | otherwise the field is absent. |
| NTN | The field is optionally present, Need S, in a cell where |
| | cellBarredNTN is included with value notBarred, |
| | otherwise the field is absent. |
| Standalone | The field is mandatory present in a cell that supports |
| | standalone operation, otherwise the field is absent. |

In some examples, the NE 102 may transmit an information element (IE) to configure cell specific parameters of a serving cell in the SIB1. An IE may refer to a basic unit of data or a structured data field that includes parameters, attributes, or instructions for conveying information between devices in the wireless communications system 100. The IE may be referred to as a ServingCellConfigCommonSIB IE and may include one or more fields as shown in Tables 6 and 7.

TABLE 6
ServingCellConfigSIB IE definition
ServingCellConfigCommonSIB field descriptions

channelAccessMode
If present, the field indicates which channel access procedures to apply for operation with shared
spectrum channel access. If the field is configured as “semiStatic,” then the UE may apply the channel
access procedures for semi-static channel occupancy. If the field is configured as “dynamic,” then the
UE may apply the channel access procedures.
channelAccessMode2
If present, the field indicates that the UE may apply channel access procedures for operation with
shared spectrum channel access for FR2-2. If absent, the UE may not apply any channel access
procedure. The network configures the field if channel access procedures are defined for the serving
cell within the region by regulations.
discoveryBurstWindowLength
Indicates the window length of the discovery burst in ms. The field discoveryBurstWindowLength-
v1700 is applicable to SCS 480 kHz and SCS 960 kHz.
enhancedMeasurementNGSO
If the field is present and UE supports the enhanced cell reselection requirements for NTN NGSO in
RRC_IDLE and/or RRC_INACTIVE, then the UE may apply the enhanced cell reselection
requirements for NTN NGSO.
groupPresence
The field is present when a maximum number of synchronization signal (SS) and/or physical broadcast
channel (PBCH) blocks per half frame equals to 64. The first and/or leftmost bit corresponds to the SS
and/or PBCH index 0-7, the second bit corresponds to SS and/or PBCH block 8-15, and so on. Value 0
in the bitmap indicates that the SSBs according to inOneGroup are absent. Value 1 indicates that the SS
and/or PBCH blocks are transmitted in accordance with inOneGroup.
inOneGroup
When a maximum number of SS and/or PBCH blocks per half frame equals to 4, the 4 leftmost bits are
valid; the UE ignores the 4 rightmost bits. When maximum number of SS and/or PBCH blocks per half
frame equals to 8, all 8 bits are valid. The first and/or leftmost bit corresponds to SS and/or PBCH
block index 0, the second bit corresponds to SS and/or PBCH block index 1, and so on. When
maximum number of SS and/or PBCH blocks per half frame equals to 64, all 8 bit are valid; The first
and/or leftmost bit corresponds to the first SS and/or PBCH block index in the group (e.g., to SSB
index 0, 8, and so on); the second bit corresponds to the second SS and/or PBCH block index in the
group (e.g., to SSB index 1, 9, and so on), and so on. Value 0 in the bitmap indicates that the
corresponding SS and/or PBCH block is not transmitted while value 1 indicates that the corresponding
SS and/or PBCH block is transmitted.
n-TimingAdvanceOffset
The N_TA-Offset to be applied for random access on the serving cell. If the field is absent, then the UE
applies the value defined for the duplex mode and frequency range of the serving cell.
ra-ChannelAccess
If present, the field indicates that the UE may apply channel access procedures before msg1 and/or
msgA transmission for operation with shared spectrum channel access for FR2-2.
ssb-PositionsInBurst
Time domain positions of the transmitted SS-blocks in an SS-burst. For operation with shared spectrum
channel access in FR1, inOneGroup is used and the UE interprets The field same as mediumBitmap in
ServingCellConfigCommon. The UE assumes that a bit in inOneGroup at position k > N_{SSB}^{QCL} is 0, where
N_{SSB}^{QCL} is obtained from a master information block (MIB). For operation with shared spectrum channel
access in FR2-2, the m-th bit in groupPresence is set to 0 for m > N_{SSB}^{QCL} and/or 8, where
N_{SSB}^{QCL} is obtained from MIB.
ss-PBCH-BlockPower
Average energy per resource element (EPRE) of the resources elements that carry secondary
synchronization signals in dBm that the network used for SSB transmission.

TABLE 7
ServingCellConfigSIB IE definition, optional fields

| Conditional Presence | Explanation |
|---|---|
| FR2-Only | The field is present for an FR2 carrier frequency. |
| | The field is absent otherwise and UE releases |
| | any configured value. |
| SharedSpectrum | The field is present if the cell operates with |
| | shared spectrum channel access in FR1. |
| | Otherwise, the field is absent, R. |
| SharedSpectrum2 | The field is optionally present if the cell operates |
| | with shared spectrum channel access in FR2-2, |
| | Need R. Otherwise, the field is absent, R. |
| TDD | The field is optionally present, R, for time |
| | division duplexing (TDD) cells; otherwise, |
| | the field is absent. |

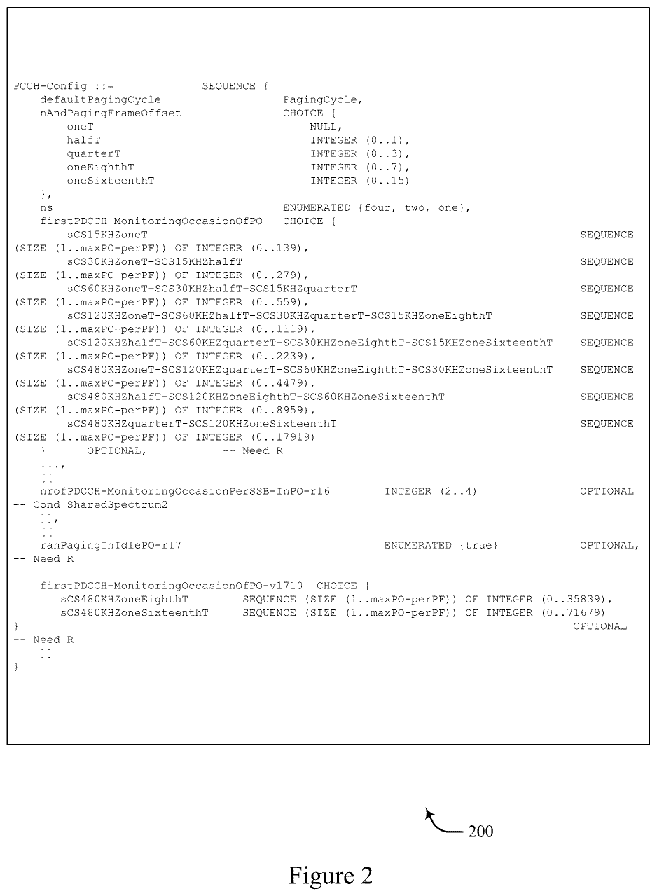

In some examples, a NE 102 may transmit an IE to one or more UEs 104 that provides common downlink parameters of a cell. The IE may be referred to as a DownlinkConfigCommonSIB IE and may be defined according to Tables 8, 9, 10, 11, 12, and 13, as well as FIG. 2.

TABLE 8
DownlinkConfigCommonSIB definition
DownlinkConfigCommonSIB field descriptions

bcch-Config
The modification period related configuration.
frequencyInfoDL-SIB
Basic parameters of a downlink carrier and transmission thereon.
initialDownlinkBWP
The initial downlink BWP configuration for a primary cell (PCell). The network configures the
locationAndBandwidth so that the initial downlink BWP contains the entire CORESET 0 of the serving
cell in the frequency domain. The UE applies the locationAndBandwidth upon reception of the field
(e.g., to determine the frequency position of signals described in relation to the locationAndBandwidth).
The UE keeps CORESET 0 until after reception of RRCSetup and/or RRCResume and/or
RRCReestablishment.
initialDownlinkBWP-RedCap
If present, (e)RedCap UEs use The DL BWP instead of initialDownlinkBWP. If the
locationAndBandwidth of the BWP includes an entire CORESET 0, then the UE applies the
locationAndBandwidth upon reception of the field (e.g., to determine the frequency position of signals
described in relation to the locationAndBandwidth). The UE keeps CORESET 0 until after reception of
RRCSetup and/or RRCResume and/or RRCReestablishment. Otherwise, (e.g., if the
locationAndBandwidth of the BWP does not include the entire CORESET 0), the UE uses the BWP for
receiving downlink messages during initial access (Msg2, MsgB, Msg4) and after initial access. If
absent, then (e)RedCap UEs use initialDownlinkBWP provided that the value does not exceed the
(e)RedCap UE maximum bandwidth.
lastUsedCellOnly
When present, the field indicates that the UE monitors paging early indication (PEI) if the latest
received RRCRelease without noLastCellUpdate is from the cell. A PEI-capable UE stores last used
cell information.
nrofPDCCH-MonitoringOccasionPerSSB-InPO
The number of PDCCH monitoring occasions corresponding to an SSB within a PO.
pcch-Config
The paging related configuration.
pei-Config
The PEI related configuration.
subgroupConfig
The paging subgroup related configuration.

TABLE 9
BCCH-Config definition
BCCH-Config field descriptions

modificationPeriodCoeff
Actual modification period, expressed in number of radio frames
m = modificationPeriodCoeff* defaultPagingCycle corresponds
to value 2, n4 corresponds to value 4, and so on.

TABLE 10
PDCCH-config definition
PCCH-Config field descriptions

defaultPagingCycle
Default paging cycle, used to derive T. Value rf32 corresponds to 32 radio frames, value rf64
corresponds to 64 radio frames and so on.
firstPDCCH-MonitoringOccasionOfPO
Points out the first PDCCH monitoring occasion for paging of each PO of the PF.
nAndPaging FrameOffset
Used to derive the number of total PFs in T and PF offset. A value of oneSixteenthT corresponds to T
and/or 16, a value of oneEighthT corresponds to T and/or 8, and so on.
If pagingSearchSpace is set to zero and if SS and/or PBCH block and CORESET multiplexing pattern
is 2 or 3:
for ssb-periodicityServingCell of 5 or 10 ms, N can be set to one of {oneT, halfT, quarterT,
oneEighthT, oneSixteenthT}
for ssb-periodicityServingCell of 20 ms, N can be set to one of {halfT, quarterT, oneEighthT,
oneSixteenthT}
for ssb-periodicityServingCell of 40 ms, N can be set to one of {quarterT, oneEighthT,
oneSixteenthT}
for ssb-periodicityServingCell of 80 ms, N can be set to one of {oneEighthT, oneSixteenthT}
for ssb-periodicityServingCell of 160 ms, N can be set to oneSixteenthT
If pagingSearchSpace is set to zero and if SS and/or PBCH block and CORESET multiplexing pattern
is 1, N can be set to one of {halfT, quarterT, oneEighthT, one SixteenthT}
If pagingSearchSpace is not set to zero, N can be configured to one of {oneT, halfT, quarterT,
oneEighthT, oneSixteenthT}
ns
Number of POs per PF.
ranPagingInIdlePO
Indicates that the network supports to send RAN paging in PO that corresponds to the iₛ as determined
by UE in RRC IDLE state.

The IE configuring the PCCH is described in further detail with respect to FIG. 2.

TABLE 11
PEI-Config definition
PEI-Config field descriptions

payloadSizeDCI-2-7
Payload size of PEI DCI (e.g., DCI format 2_7). The size
is no larger than the payload size of paging DCI which has
maximum of 41 bits and 43 bits for licensed and unlicensed
spectrums, respectively.
pei-FrameOffset
Offset, in number of frames from the start of a reference
frame for PEI-O to the start of a first PF of the PFs
associated with the PEI-O.
po-NumPerPEI
The number of PO(s) associated with one PEI monitoring
occasion, which is a factor of the total PO number in
a paging cycle (e.g., N × Ns). The maximum number of
PF associated with one PEI monitoring occasion is 2. The
number of PO mapping to one PEI should be multiple of Ns
when po-NumPerPEI is larger than Ns.

TABLE 12
SubgroupConfig definition
SubgroupConfig field descriptions

subgroupsNumPerPO
Total number of subgroups per PO for UE to read subgroups
indication from physical layer signaling. The field represents
the sum of CN-assigned and UE ID-based subgroups supported
by the network .When PEI-Config is configured, there is always
at least one subgroup (UE ID-based subgroup or CN-assigned
subgroup) configured.
subgroupsNumForUEID
Number of subgroups per PO for UE to read subgroups indication
from physical-layer signaling, for UEID-based subgrouping method.
When present, the field is set to an integer smaller than or equal
to subgroupsNumPerPO. subgroupsNumPerPO equals to
subgroupsNumForUEID when the network does not configure
CN-assigned subgrouping. When pei-Config is configured,
the field is absent when the network configures CN-assigned
subgrouping. Both The field and subgroupsNumPerPO are
equal to 1 when the network does not configure subgrouping.
When pei-Config is configured, if the field is absent,
the UE uses defined subgrouping.

TABLE 13
SubgroupConfig definition, conditional fields

| Conditional Presence | Explanation |
|---|---|
| SharedSpectrum2 | The field is optional present, R, if the cell |
| | operates with shared spectrum channel access. |
| | Otherwise, the field is absent, R. |

A paging cycle is a time interval between successive POs during which a UE 104 in idle mode is expected to monitor the paging channel for incoming paging messages. The DRX mechanism is used to reduce the power consumption of the UE 104 by enabling the UE 104 to periodically switch off a receiver during idle periods. Paging cycle DRX refers to the use of DRX in conjunction with the paging cycle to further reduce the power consumption of the UE 104. With paging cycle DRX, the UE 104 may monitor the paging channel during specific DRX periods within each paging cycle, instead of monitoring the channel continuously throughout the cycle. The paging cycle DRX mechanism is implemented by defining two parameters the DRX cycle and the paging cycle. The DRX cycle is the time interval during which receiver of the UE 104 is switched off, while the paging cycle is the time interval between successive POs. The DRX cycle duration may be shorter than the paging cycle and is expressed as a multiple of the subframe duration. During the paging cycle DRX operation, the UE 104 turns off a receiver during the DRX period and wakes up briefly at the end of each DRX period to check if there is any paging message on the paging channel. If there is no paging message, then the UE 104 goes back to sleep and repeats the DRX cycle until the end of the current paging cycle. If there is a paging message, then the UE 104 will wake up fully and initiate a connection with the network (e.g., a NE 102) to receive a message and respond, accordingly. The paging cycle DRX mechanism enables the UE 104 to save power by reducing the amount of time the UE 104 may monitor the paging channel during idle periods. The paging cycle DRX mechanism results in longer battery life and improves overall UE 104 performance.

In some examples, a network expends substantial energy (e.g., greater than a threshold amount of energy) in transmitting SSBs and PBCHs (e.g., including a MIB and SIB1). The SSBs (e.g., apart from SIB1) can be provided on demand. SIB1 carries a configuration for reception of paging messages by a UE 104, among other information. If SIB1 changes, then the UE 104 is notified by a DCI format 1_0 scrambled with a P-RNTI. The DCI includes a short messages field with a first bit set to a value (e.g., systemInfoModification), and the DCI may optionally schedule a paging message in a scheduled downlink shared channel (e.g., physical downlink shared channel (PDSCH). To save energy at the network and/or the UE 104 side, the paging configuration of a cell may adapt to a number of UEs within coverage of a cell. To adapt one or more paging configuration parameters, such as the periodicity, the network may update the SIB1 configuration, and additionally indicate to UEs 104 that SI has changed by transmitting a DCI format 1_0 scrambled with P-RNTI (e.g., with a short messages field where the first bit is set).

For a UE 104 in IDLE and/or INACTIVE mode, the UE 104 and a NE 102 may perform a paging configuration update. For example, the UE 104 may wake up to check whether the UE 104 has received a DCI format 1_0 scrambled with P-RNTI with a set short message bit systemInfoModification. The UE 104 may wake up at the next potential SIB1 transmission occasion to receive the updated paging configuration. The UE 104 applies the updated paging configuration from the start of the next modification period. Such a procedure leads to a UE 104 waking up and processing information multiple times (e.g., processing the DCI and the SIB1), and may incur some latency before updated paging configuration parameters are applied.

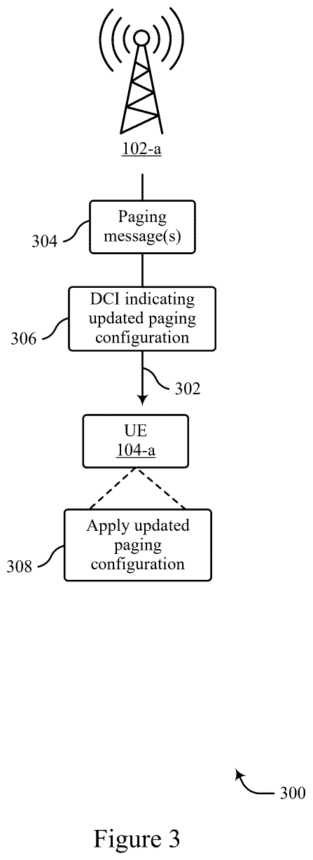

According to implementations, one or more of the NEs 102 and the UEs 104 are operable to implement various aspects of the techniques described with reference to the present disclosure. For example, an NE 102 may indicate one or more changes to a paging configuration to a UE 104 by fields included in control information. For example, the fields may be included in a DCI carrying paging related information, such as DCI format 1_0 scrambled with P-RNTI, which is described in further detail with respect to FIG. 3. The UE 104 may update the paging configuration using the information received in the DCI (e.g., without monitoring for and processing a SIB1 transmission).

Reference is made herein to communicating data or information, such as signaling configurations and/or communications that are transmitted or received between devices. It is to be appreciated that other terms may be used interchangeably with communicating, such as signaling, transmitting, receiving, outputting, forwarding, retrieving, obtaining, and so forth.

FIG. 2 illustrates an example of a downlink control channel configuration 200 in accordance with aspects of the present disclosure. In some examples, the downlink control channel configuration 200 implements or is implemented by aspects of the wireless communications system 100. For example, the downlink control channel configuration 200 may be implemented by a NE 102 and a UE 104, which may be examples of the corresponding devices as described with reference to FIG. 1. The NE 102 may transmit signaling (e.g., control signaling) including the downlink control channel configuration 200.

In some cases, the downlink control channel configuration 200 may include (e.g., configure) one or more parameters. The parameters may include, but are not limited to, a default paging cycle (e.g., a duration and periodicity of the paging cycle), a PF offset, a first monitoring occasion of a PO, a numerical quantity of POs within a PF, and a RAN paging in idle PO parameter, among other examples. The NE 102 may transmit the downlink control channel configuration 200 in a SIB1. Additionally, or alternatively, the NE 102 may transmit an update to one or more parameters in the downlink control channel configuration 200 via a DCI and/or a downlink shared channel transmission.

FIG. 3 illustrates an example of a wireless communications system 300 in accordance with aspects of the present disclosure. In some examples, the wireless communications system 300 implements or is implemented by aspects of the wireless communications system 100 and the downlink control channel configuration 200. For example, the wireless communications system 300 may include a UE 104-a and a NE 102-a, which may be examples of the corresponding devices as described with reference to FIG. 1. The NE 102-a may communicate with the UE 104-a via a downlink communications link 202. For example, the NE 102-a may transmit signaling related to paging via the downlink communications link 202.

In some examples, the NE 102-a may transmit a paging configuration to the UE 104-a (e.g., in a SIB1 or other control signaling). The NE 102 may determine one or more conditions are met for updating the paging configuration. The NE 102 may adjust (e.g., update, modify) one or more parameter values of parameters included in the paging configuration, such as the paging cycle or the number of POs. The NE 102 may adjust the parameter values to balance power saving for UEs 104 with latency criterion of the NE 102 or the UEs 104. For example, during periods of relatively high network congestion (e.g., greater than a threshold number of signaling exchanged between devices in the wireless communications system 300), the NE 102 may modify parameters in the paging configuration to distribute paging messages 304 more evenly across available resources, reducing collisions and improving paging success rates. Additionally, or alternatively, the NE 102 may evaluate energy efficiency of UEs 104 when determining whether to update a paging configuration. The NE 102 may enhance battery life (e.g., reduce power consumption) of a UE 104 by providing for longer sleep cycles or reducing the frequency that the UEs 104 are waking up from an idle mode. Additionally, or alternatively, the NE 102 may adjust parameters of a paging configuration to support service criterion, such as to account for low-latency services or satisfying one or more quality of service (QoS) thresholds.

The NE may transmit control signaling that indicates a change (e.g., adjustment, update, modification) of a paging configuration. For example, one or more fields in the control signaling may indicate respective changes to parameters in a paging configuration. The NE 102 may include the fields in a DCI format carrying paging related information, such as DCI format 1_0 scrambled with P-RNTI. For example, the NE 102-a may transmit a DCI indicating an updated paging configuration 306. In some cases, the DCI indicating an updated paging configuration 306 may include a short messages indicator that indicates a change of a paging configuration. For example, one bit or value of a short messages indicator field indicates the change to a paging cycle of a UE 104-a, as shown in Table 14.

TABLE 14
New short messages indicator definition

| Bit field | Short message indicator |
|---|---|
| 00 | Paging cycle configuration is present in the DCI |
| 01 | Scheduling information for paging, and TRS availability |
| | indication if trs-ResourceSetConfig is configured, |
| | are present in the DCI |
| 10 | Short message, and TRS availability indication if trs- |
| | ResourceSetConfig is configured, are present in the DCI |
| 11 | Both scheduling information for paging, TRS availability |
| | indication if trs-ResourceSetConfig is configured, and |
| | short message are present in the DCI |

In some other cases, one or more bits in a short messages field of the DCI indicating an updated paging configuration 306 may indicate a change of a paging configuration, such as a change of a paging cycle configuration, as shown in Table 15.

TABLE 15
New short messages definition

| Bit | Short message |
|---|---|
| 1 | systemInfoModification |
| | If set to 1: indication of a BCCH modification other than |
| | SIB6, SIB7, SIB8 and posSIBs. |
| 2 | etwsAndCmasIndication |
| | If set to 1: indication of an ETWS primary notification and/or |
| | an ETWS secondary notification and/or a CMAS notification. |
| 3 | stopPagingMonitoring |
| | Used for operation with shared spectrum channel access and |
| | if nrofPDCCH-MonitoringOccasionPerSSB-InPO is present. If |
| | set to 1: indication that the UE 104-a may stop |
| | monitoring PDCCH occasion(s) for paging in this PO. |
| 4 | systemInfoModification-eDRX |
| | If set to 1: indication of a BCCH modification other |
| | than SIB6, SIB7, SIB8 and posSIBs. |
| | The indication applies to UEs using IDLE eDRX cycle longer |
| | than a BCCH modification period. |
| 5 | pagingCycleIndication |
| | If set to 1: indication of a PCCH-config modification. |
| 6-8 | Ignored by UE if received. |

In some cases, the NE 102-a transmits control information that includes one or more fields that indicate the new (e.g., updated, modified, adjusted) values of the parameters of the paging configuration. The UE 104-a may apply the new values of the parameters if the control information indicates a change of paging configuration parameters (e.g., in the short messages indicator or in the short messages field of a DCI). For example, the DCI indicating updated paging configuration 306 may include one or more fields that indicate the update to the values of the parameters. The NE 102-a transmits the DCI indicating updated paging configuration 306 according to a DCI format 1_0 with CRC scrambled by P-RNTI.

The DCI indicating updated paging configuration 306 may include two bits for a short messages indicator, according to Table 14. Additionally, or alternatively, the DCI indicating updated paging configuration 306 may include eight bits for one or more short messages. If the DCI indicating updated paging configuration 306 includes scheduling information for paging, and TRS availability indication if trs-Resource SetConfig or trs-ResourceSetConfig-r18 is configured, are carried (e.g., by the DCI indicating updated paging configuration 306), then the short messages field is reserved. If paging cycle configuration is carried (e.g., as indicated by the short messages indicator), then the short messages field may carry one or more updated values of parameters of a paging configuration. For example, the short messages field may include, but is not limited to, one or more of defaultPagingCycle, nAndPagingFrameOffset, ns, or ranPagingInIdlePO parameters (e e.g., of a PCCH-Config, as described with reference to FIG. 2).

Additionally, or alternatively, the DCI indicating updated paging configuration 306 may include a number of bits allocated for a frequency domain resource assignment (e.g.,

$$⌈ {log}_{2} ( {N}_{R B}^{D L , B W P} ( {N}_{R B}^{D L , B W P} + 1 ) / 2 ) ⌉ bits .$$

trs-ResourceSetConfig or trs-ResourceSetConfig-r18 is configured, are carried (e.g., by the DCI indicating updated paging configuration 306), then the frequency domain resource assignment bit field is reserved. If paging cycle configuration is carried (e.g., by the DCI indicating updated paging configuration 306), then the frequency domain resource assignment bit field carries one or more updated values of parameters of a paging configuration. For example, the frequency domain resources assignment field may include one or more of defaultPagingCycle, nAndPagingFrameOffset, ns, or ranPagingInIdlePO parameters (e.g., of a PCCH-Config, as described with reference to FIG. 2). The value of

$${N}_{R B}^{DL , BWP}$$

is the size of CORESET 0. Additionally, or alternatively, the DCI indicating updated paging configuration 306 may include a number of bits allocated for a time domain resource assignment (e.g., four bits). If the short message, and TRS availability indication if trs-Resource SetConfig or trs-ResourceSetConfig-r18 is configured, are carried (e.g., by the DCI indicating updated paging configuration 306), then the time domain resource assignment field is reserved. If paging cycle configuration is carried (e.g., by the DCI indicating updated paging configuration 306), then the time domain resource assignment bit field carries one or more updated values of parameters of a paging configuration. For example, the time domain resource assignment field may include one or more of defaultPagingCycle, nAndPagingFrameOffset, ns, or ranPagingInIdlePO parameters (e.g., of a PCCH-Config, as described with reference to FIG. 2). Additionally, or alternatively, the DCI indicating updated paging configuration 306 may include a bit that indicates a VRB-to-PRB mapping. If the short message, and TRS availability indication if trs-ResourceSetConfig or trs-ResourceSetConfig-r18 is configured, are carried (e.g., by the DCI indicating updated paging configuration 306), then the VRB-to-PRB mapping field is reserved. If paging cycle configuration is carried (e.g., by the DCI indicating updated paging configuration 306), then the VRB-to-PRB mapping field carries one or more updated values of parameters of a paging configuration. For example, the VRB-to-PRB mapping field may include one or more of defaultPagingCycle, nAndPagingFrameOffset, ns, or ranPagingInIdlePO parameters (e.g., of a PCCH-Config, as described with reference to FIG. 2).

Additionally, or alternatively, the DCI indicating updated paging configuration 306 may include five bits that indicate an MCS. If the short message, and TRS availability indication if trs-ResourceSetConfig or trs-ResourceSetConfig-r18 is configured, are carried (e.g., by the DCI indicating updated paging configuration 306), the MCS bit field is reserved. If a paging cycle configuration is carried, then the MCS bit field carries one or more updated values of parameters of a paging configuration. For example, the MCS field may include one or more of defaultPagingCycle, nAndPagingFrameOffset, ns, or ranPagingInIdlePO parameters (e.g., of a PCCH-Config, as described with reference to FIG. 2). Additionally, or alternatively, the DCI indicating updated paging configuration 306 may include two bits that indicate TB scaling. If the short message, and TRS availability indication if trs-ResourceSetConfig or trs-ResourceSetConfig-r18 is configured, are carried (e.g., by the DCI indicating updated paging configuration 306), then the TB scaling bit field is reserved. If paging cycle configuration is carried, then the TB scaling bit field carries one or more updated values of parameters of a paging configuration. For example, the TB scaling field may include one or more of defaultPagingCycle, nAndPagingFrameOffset, ns, or ranPagingInIdlePO parameters (e.g., of a PCCH-Config, as described with reference to FIG. 2). Additionally, or alternatively, the DCI indicating updated paging configuration 306 may include one or more bits (e.g., one, two, three, four, five, or six bits) that indicate a TRS availability. The number of bits may be equal to one plus a highest value of the indBitID(s) provided by the trs-ResourceSetConfig, if configured, or a number of bits is equal to one plus the highest value of all the indBitID-r18(s) provided by the trs-Resource SetConfig-r18, if configured; 0 bits otherwise. Additionally, or alternatively, the DCI indicating updated paging configuration 306 may include one or more reserved bits (e.g., (8-M) bits for operation in a cell with shared spectrum channel access in FR1 or for operation in a cell in FR2-2; (6-M) bits for operation in a cell without shared spectrum channel access, where the value of M is the number of bits for the field of TRS availability indication).

If the NE 102-a transmits control information that indicates an update to a paging configuration (e.g., the DCI indicating updated paging configuration 306), then the control information may include scheduling information for a message. For example, a short messages indicator in DCI may indicate that the DCI includes scheduling information for a paging cycle configuration, as shown in Table 16. The NE 102-a may include the message in a downlink shared channel, such as a PDSCH. The message may include new or updated values of one or more parameters of a paging configuration.

TABLE 16
New short messages indicator for downlink
shared channel transmission

| Bit field | Short Message indicator |
|---|---|
| 00 | Scheduling information for paging cycle configuration is |
| | present in the DCI |
| 01 | Scheduling information for paging, and TRS availability |
| | indication if trs-ResourceSetConfig is configured, |
| | are present in the DCI |
| 10 | Short message, and TRS availability indication if trs- |
| | ResourceSetConfig is configured, are present in the DCI |
| 11 | Both scheduling information for Paging, TRS availability |
| | indication if trs-ResourceSetConfig is configured, and |
| | short message are present in the DCI |

If the short messages indicator indicates that the DCI (e.g., the DCI indicating updated paging configuration 306) includes scheduling information for a paging configuration, then the DCI may include an indication of one or more time-frequency resources (e.g., in a PDSCH), that the UE 104-a is to monitor for the update to the paging configuration. The NE 102-a may transmit the message or PDSCH transmission, including the update to the paging configuration to the UE 104-a. The message may include one or more fields that indicate updated values of one or more parameters of the paging configuration, such as the parameters in the PDCCH-config, as described with reference to FIG. 2.

In some examples, the NE 102-a may dynamically choose (e.g., select) between DCI-based and PDSCH-based paging configuration. For example, the NE 102-a may include a short messages field in the DCI indicating updated paging configuration 306 to indicate whether the update to the paging configuration (e.g., a PCCH-config modification) is included in the DCI or in a scheduled PDSCH, as shown in Table 17.

TABLE 17
New short messages definition for dynamic selection between
DCI and PDSCH for paging configuration updates

| Bit | Short Message |
|---|---|
| 1 | systemInfoModification |
| | If set to 1: indication of a BCCH modification other |
| | than SIB6, SIB7, SIB8 and posSIBs. |
| 2 | etwsAndCmasIndication |
| | If set to 1: indication of an ETWS primary notification and/or |
| | an ETWS secondary notification and/or a CMAS notification. |
| 3 | stopPagingMonitoring |
| | This bit can be used for only operation with shared spectrum |
| | channel access and if nrofPDCCH-MonitoringOccasionPerSSB-InPO |
| | is present. If set to 1: indication that the UE may stop |
| | monitoring PDCCH occasion(s) for paging in this PO. |
| 4 | systemInfoModification-eDRX |
| | If set to 1: indication of a BCCH modification other than |
| | SIB6, SIB7, SIB8 and posSIBs. This indication applies only |
| | to UEs using IDLE eDRX cycle longer than the BCCH |
| | modification period. |
| 5 | pagingCycleIndicationDCI |
| | If set to 1: indication of a PCCH-config modification in the DCI. |
| 6 | pagingCycleIndicationPDSCH |
| | If set to 1: indication of a PCCH-config modification |
| | in the scheduled PDSCH. |
| 7-8 | Ignored by UE if received. |

In some other examples, the NE 102-a may include a short messages indicator field in the DCI indicating updated paging configuration 306 to indicate whether the update to the paging configuration (e.g., a PCCH-config modification) is included in the DCI or in a scheduled PDSCH. In some cases, the short messages indicator field may indicate a presence of an update to the paging configuration (e.g., a PCCH-config modification), while the short messages field indicates whether the modification is included in the DCI or in the scheduled PDSCH, as shown in Tables 18 and 19.

TABLE 18
New short messages indicator for indicating
presence of update to paging configuration

| Bit field | Short Message indicator |
|---|---|
| 00 | Paging cycle configuration is modified |
| 01 | Scheduling information for paging, and TRS |
| | availability indication if trs-ResourceSetConfig |
| | is configured, are present in the DCI |
| 10 | Short message, and TRS availability indication |
| | if trs-ResourceSetConfig is configured, are |
| | present in the DCI |
| 11 | Both scheduling information for paging, TRS |
| | availability indication if trs-ResourceSetConfig is |
| | configured, and short message are present in the DCI |

TABLE 19
New short messages definition for dynamic selection between
DCI and PDSCH for paging configuration updates

| Bit | Short message |
|---|---|
| 1 | systemInfoModification |
| | If set to 1: indication of a BCCH modification |
| | other than SIB6, SIB7, SIB8 and posSIBs. |
| 2 | etwsAndCmasIndication |
| | If set to 1: indication of an ETWS primary notification |
| | and/or an ETWS secondary notification and/or a |
| | CMAS notification. |
| 3 | stopPagingMonitoring |
| | This bit can be used for only operation with shared |
| | spectrum channel access and if nrofPDCCH- |
| | MonitoringOccasionPerSSB-InPO is present. If set to 1: |
| | indication that the UE may stop monitoring PDCCH |
| | occasion(s) for paging in this PO. |
| 4 | systemInfoModification-eDRX |
| | If set to 1: indication of a BCCH modification other than |
| | SIB6, SIB7, SIB8 and posSIBs. |
| | This indication applies only to UEs using IDLE eDRX cycle |
| | longer than the BCCH modification period. |
| 5 | pagingCycleIndication |
| | If set to 0: indication of a PCCH-config modification in the DCI. |
| | If set to 1: indication of a PCCH-config modification. |
| 6-8 | Ignored by UE if received. |

In some examples, the control information (e.g., the DCI indicating updated paging configuration 306) or the message scheduled by the control information includes an indication of one of a set of configured paging configurations. For example, SI or RRC configurations may configure a set of paging configurations, such as a first paging configuration including a first paging cycle and a first PF offset, a second paging configuration including a second paging cycle and a second PF offset. The DCI indicating updated paging configuration 306 may then indicate which configuration out of the configured set of configurations is to be applied. For example, a field in the DCI indicating updated paging configuration 306 may activate (e.g., select, indicate) one of the paging configurations defined (e.g., preconfigured) at the UE 104-a. The indication can be included in the short messages indicator field, in the short messages field, included in a message scheduled by the control information, and/or one of the control information fields (e.g., the fields in the body of the DCI).

In some examples, the control information or the message carried in a TB according to the scheduling information, further identifies one or more of a group of UEs and/or whether the update to the paging reconfiguration affects RRC_ACTIVE UEs, RRC_INACTIVE UEs, or RRC_IDLE UEs. At 308, the UE 104-a applies the updated paging configuration (e.g., according to timing information). For example, the UE 104-a may apply the updated paging configuration from a start of a next modification period, after a next paging DRX cycle, or according to a configured timing. The timing may be part of the paging configuration or other configuration elements or parameters (e.g., in RRC signaling) and may indicate one or more of a timing after reception of the updated paging configuration or a timing relative to an SFN. In some examples, the paging configuration parameters include one or more of the parameters included in a PCCH-config IE, as described with reference to FIG. 2. In some cases, any paging cycle parameters, such as in PCCH-config, that are conveyed by a SIB (e.g., SIBx) transmitted by a NE 102-a after the DCI or the PDSCH indicate a same settings (e.g., parameters, paging configuration) as the settings indicated by the DCI or the PDSCH. The UE 104-a may receive one or more paging messages 308 according to the applied updated paging configuration.

In some examples, in addition to, or as an alternative to, a paging configuration, the NE 102-a may indicate an update to a different configuration (e.g., other group-wide or cell-wide configurations). For example, the NE 102-a may apply similar techniques for configurations, such as IE that are included in a MIB or SIB1. The NE 102-a may reconfigure (e.g., update, modify, adjust, change) SIB1 contents, including one or more of a cellSelectionInfo parameter, an si-SchedulingInfo parameter, an eDRX-AllowedIdle parameter, an eDRX-AllowedInactive parameter, or an idleModeMeasurementsNR parameter, which may be preconfigured or otherwise defined.

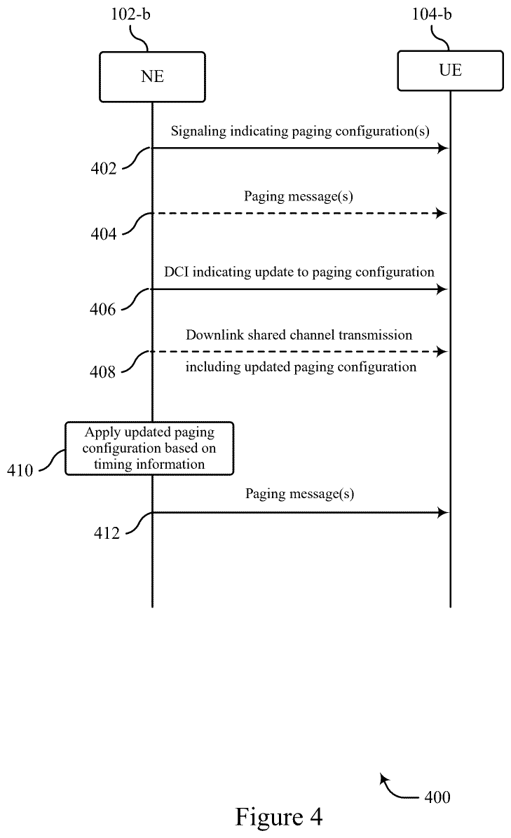

FIG. 4 illustrates an example signaling diagram 400 in accordance with aspects of the present disclosure. In some examples, the signaling diagram 400 implements or is implemented by aspects of the wireless communications system 100, the downlink control channel configuration 200, and wireless communications system 300. The signaling diagram 400 may implement or be implemented by a UE 104-b and a NE 102-b, which may be examples of the corresponding devices as described with reference to FIGS. 1 through 3. For example, the NE 102-b may provide the UE 104-b with an updated paging configuration using DCI (e.g., rather than a SIB1). Alternative examples of the following may be implemented, where some processes are performed in a different order than described or are not performed. In some cases, processes may include additional features not mentioned below, or further processes may be added.

At 402, the NE 102-b transmits signaling to the UE 104-b indicating one or more paging configurations. For example, the signaling may include a set of parameters that the UE 104-b uses to determine when to monitor for one or more paging messages. The signaling may be an example of control signaling, such as RRC signaling or a SIB1 transmission. The paging configurations may include an initial paging configuration for the UE 104-b to use to monitor for paging messages and/or a set of paging configurations.

In some cases, at 404, the NE 102-b transmits one or more paging messages to the UE 104-b. For example, the NE 102-b transmits one or more paging messages to the UE 104-b using an initial paging configuration, which the NE 102-b transmits at 402.

At 406, the NE 102-b transmits DCI to the UE 104-b indicating an update to the paging configuration (e.g., an initial paging configuration received at 402). The DCI includes at least one element (e.g., one or more elements of a short messages indicator or short messages field) that indicates an update to one or more parameters of a paging configuration. The paging configuration may include the set of parameters for receiving paging messages. The one or more parameters being updated may include at least one of an updated paging cycle, a PF offset, a numerical quantity of POs within a PF, or a RAN paging in an idle PO parameter.

In some cases, the element may include a short messages indicator of the DCI, where the short messages indicator indicates one or more bits of the DCI include the update to the one or more parameters of the paging configuration (e.g., one or more bits in the body of the DCI or one or more bits in a short messages field). In some other cases, the element may include an element of a short messages field of the DCI, where the element indicates one or more bits of the DCI include the update to the one or more parameters of the paging configuration. In some examples, the element includes a short messages indicator of the DCI or a short messages field of the DCI, where the short messages indicator or the short messages field indicate one or more bits of the DCI include scheduling information for a downlink shared channel transmission (e.g., a message in a PDSCH) including the update to the one or more parameters of the paging configuration. If the DCI schedules a downlink shared channel transmission that includes the update to the paging configuration, at 408, the NE 102-b transmits the downlink shared channel transmission to the UE 104-b, which includes the updated paging configuration.

In some other examples, the element may include a first element of a short messages field of the DCI and a second element of the short messages field of the DCI. The first element indicates one or more bits of the DCI include the update to the one or more parameters, while the second element indicates one or more bits of a scheduled downlink shared channel transmission include the update to the one or more parameters. The at least one element may further include a short messages indicator of the DCI, which indicates that the one or more parameters are being updated.

At 410, the NE 102-b applies the updated paging configuration based on timing information. This timing information may include at least one of a start of a modification period of the one or more paging messages, an end of a paging cycle subsequent to the DCI, a duration after transmission of the DCI, or a duration relative to an SFN. The NE 102-b may configure the timing information in control signaling, such as the DCI, RRC signaling, or a SIB 1, among other examples.

At 412, the NE 102-b transmits one or more paging messages to the UE 104-b. For example, the NE 102-b uses the updated paging configuration to transmit the paging messages. The UE 104-b monitors for the paging messages using the updated paging configuration (e.g., according to updated values of one or more parameters of the paging configuration).

In some cases, the NE 102-b may transmit the DCI to a group of UEs including the UE 104-b. Additionally, or alternatively, the DCI may indicate for the UE 104-b to apply the update to the one or more parameters according to a state of the UE 104-b, where the state of the UE includes at least one of an active state (e.g., RRC_ACTIVE), an inactive state (e.g., RRC_INNACTIVE), or an idle state (e.g., RRC_IDLE). RRC states define a connection status between the UE 104-b and the NE 102-b. In an RRC_ACTIVE state, which may also be referred to as RRC_CONNECTED, the UE 104-b may have established an RRC connection with the NE 102-b, providing for data transfer and signaling exchange. The UE 104-b maintains a dedicated control channel and can actively communicate with the NE 102-b in the RRC_ACTIVE state. In the RRC_IDLE state, the UE 104-b may not have an active RRC connection, but may maintain a registration with the NE 102-b. The UE 104-b may periodically monitor paging channels for incoming transmissions and can initiate connection requests. In the RRC_INACTIVE state, the UE 104-b retains some context information from a previous connection, providing for faster state transitions compared to RRC_IDLE, while still reducing energy consumption.

In some examples, prior to receiving the DCI, the UE 104-b may receive signaling that indicates a set of paging configurations paging (e.g., at 402). A first paging configuration of the set of configurations may include the set of parameters (e.g., an initial paging configuration), while a second paging configuration of the set of configurations may include the update to the parameters. The NE 102-b may transmit the parameter in the DCI to activate the first configuration or the second configuration. In some cases, the DCI transmitted by the NE 102-b is scrambled with a P-RNTI, providing for the UE 104-b to identify the DCI as including paging-related information. In some examples, any subsequent SIBs to the DCI may include the updated parameters. That is, the NE 102-b may transmit one or more SIBs after the DCI, where the one or more SIBs include the update to the one or more parameters.

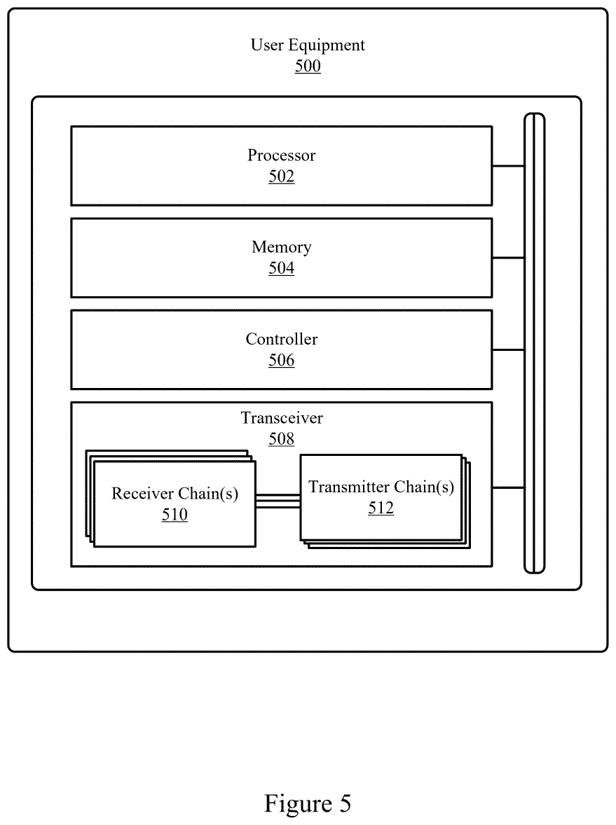

FIG. 5 illustrates an example of a UE 500 in accordance with aspects of the present disclosure. The UE 500 may include a processor 502, a memory 504, a controller 506, and a transceiver 508. The processor 502, the memory 504, the controller 506, or the transceiver 508, or various combinations thereof or various components thereof may be examples of means for performing various aspects of the present disclosure as described herein. These components may be coupled (e.g., operatively, communicatively, functionally, electronically, electrically) via one or more interfaces.

The processor 502, the memory 504, the controller 506, or the transceiver 508, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 502 may include an intelligent hardware device (e.g., a general-purpose processor, a DSP, a CPU, an ASIC, an FPGA, or any combination thereof). In some implementations, the processor 502 may be configured to operate the memory 504. In some other implementations, the memory 504 may be integrated into the processor 502. The processor 502 may be configured to execute computer-readable instructions stored in the memory 504 to cause the UE 500 to perform various functions of the present disclosure.

The memory 504 may include volatile or non-volatile memory. The memory 504 may store computer-readable, computer-executable code including instructions when executed by the processor 502 cause the UE 500 to perform various functions described herein. The code may be stored in a non-transitory computer-readable medium such as the memory 504 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 502 and the memory 504 coupled with the processor 502 may be configured to cause the UE 500 to perform one or more of the functions described herein (e.g., executing, by the processor 502, instructions stored in the memory 504). For example, the processor 502 may support wireless communication at the UE 500 in accordance with examples as disclosed herein. The UE 500 may be configured to or operable to support a means for receiving DCI including at least one element that indicates an update to one or more parameters of a set of parameters associated with one or more paging messages, and monitoring for the one or more paging messages based on the update to the one or more parameters.

Additionally, the UE 500 may be configured to support any one or combination of the at least one element includes a short messages indicator of the DCI, and where the short messages indicator indicates one or more bits of the DCI include the update to the one or more parameters. Additionally, or alternatively, the UE 500 may be configured to support the at least one element includes an element of a short messages field of the DCI, and where the element indicates one or more bits of the DCI include the update to the one or more parameters. Additionally, or alternatively, the UE 500 may be configured to support the at least one element includes a short messages indicator of the DCI, and where the short messages indicator indicates one or more bits of the DCI include scheduling information for a downlink shared channel transmission including the update to the one or more parameters. Additionally, or alternatively, the UE 500 may be configured to support receiving the downlink shared channel transmission based on the scheduling information. Additionally, or alternatively, the UE 500 may be configured to support the at least one element includes a first element of a short messages field of the DCI and a second element of the short messages field of the DCI, where the first element indicates one or more bits of the DCI include the update to the one or more parameters and the second element indicates one or more bits of a scheduled downlink shared channel transmission include the update to the one or more parameters.

Additionally, or alternatively, the UE 500 may be configured to support the at least one element further includes a short messages indicator of the DCI, and where the short messages indicator indicates that the one or more parameters are being updated. Additionally, or alternatively, the UE 500 may be configured to support receiving the scheduled downlink shared channel transmission based on the DCI. Additionally, or alternatively, the UE 500 may be configured to support receiving, prior to the DCI, signaling that indicates a set of configurations associated with paging, where a first configuration of the set of configurations includes the set of parameters associated with the one or more paging messages and where a second configuration of the set of configurations includes the update to the one or more parameters of the set of parameters associated with the one or more paging messages, and where the at least one element activates the first configuration or the second configuration. Additionally, or alternatively, the UE 500 may be configured to support the DCI is associated with a group of UEs including the UE.

Additionally, or alternatively, the UE 500 may be configured to support the DCI indicates to apply the update to the one or more parameters based on a state of the UE, where the state of the UE includes at least one of an active state, an inactive state, or an idle state. Additionally, or alternatively, the UE 500 may be configured to support applying the update to the one or more parameters based on timing information, where the timing information includes at least one of a start of a modification period associated with the one or more paging messages, an end of a paging cycle subsequent to the DCI, a duration after reception of the DCI, or a duration relative to an SFN. Additionally, or alternatively, the UE 500 may be configured to support receiving, prior to the DCI, signaling that indicates the set of parameters associated with the one or more paging messages, and monitoring, based on the set of parameters, for the DCI, where the DCI is scrambled with a P-RNTI. Additionally, or alternatively, the UE 500 may be configured to support the one or more parameters include at least one of an updated paging cycle, a PF offset, a numerical quantity of POs within a PF, or a RAN paging in an idle PO parameter.

Additionally, or alternatively, the UE 500 may support at least one memory (e.g., the memory 504) and at least one processor (e.g., the processor 502) coupled with the at least one memory and configured to cause the UE to receive DCI including at least one element that indicates an update to one or more parameters of a set of parameters associated with one or more paging messages, and monitor for the one or more paging messages based on the update to the one or more parameters.

Additionally, the UE 500 may be configured to support any one or combination of the at least one element includes a short messages indicator of the DCI, and where the short messages indicator indicates one or more bits of the DCI include the update to the one or more parameters. Additionally, or alternatively, the UE 500 may be configured to support the at least one element includes an element of a short messages field of the DCI, and where the element indicates one or more bits of the DCI include the update to the one or more parameters. Additionally, or alternatively, the UE 500 may be configured to support the at least one element includes a short messages indicator of the DCI, and where the short messages indicator indicates one or more bits of the DCI include scheduling information for a downlink shared channel transmission including the update to the one or more parameters. Additionally, or alternatively, the UE 500 may be configured to support receiving the downlink shared channel transmission based on the scheduling information. Additionally, or alternatively, the UE 500 may be configured to support the at least one element includes a first element of a short messages field of the DCI and a second element of the short messages field of the DCI, where the first element indicates one or more bits of the DCI include the update to the one or more parameters and the second element indicates one or more bits of a scheduled downlink shared channel transmission include the update to the one or more parameters. Additionally, or alternatively, the UE 500 may be configured to support the at least one element further includes a short messages indicator of the DCI, and where the short messages indicator indicates that the one or more parameters are being updated.

Additionally, or alternatively, the UE 500 may be configured to support receiving the scheduled downlink shared channel transmission based on the DCI. Additionally, or alternatively, the UE 500 may be configured to support receiving, prior to the DCI, signaling that indicates a set of configurations associated with paging, where a first configuration of the set of configurations includes the set of parameters associated with the one or more paging messages and where a second configuration of the set of configurations includes the update to the one or more parameters of the set of parameters associated with the one or more paging messages, and where the at least one element activates the first configuration or the second configuration. Additionally, or alternatively, the UE 500 may be configured to support the DCI is associated with a group of UEs including the UE.

Additionally, or alternatively, the UE 500 may be configured to support the DCI indicates to apply the update to the one or more parameters based on a state of the UE, where the state of the UE includes at least one of an active state, an inactive state, or an idle state. Additionally, or alternatively, the UE 500 may be configured to support applying the update to the one or more parameters based on timing information, where the timing information includes at least one of a start of a modification period associated with the one or more paging messages, an end of a paging cycle subsequent to the DCI, a duration after reception of the DCI, or a duration relative to an SFN. Additionally, or alternatively, the UE 500 may be configured to support receiving, prior to the DCI, signaling that indicates the set of parameters associated with the one or more paging messages, and monitoring, based on the set of parameters, for the DCI, where the DCI is scrambled with a P-RNTI. Additionally, or alternatively, the UE 500 may be configured to support the one or more parameters include at least one of an updated paging cycle, a PF offset, a numerical quantity of POs within a PF, or a RAN paging in an idle PO parameter.

The controller 506 may manage input and output signals for the UE 500. The controller 506 may also manage peripherals not integrated into the UE 500. In some implementations, the controller 506 may utilize an operating system such as iOS®, ANDROID®, WINDOWS®, or other operating systems. In some implementations, the controller 506 may be implemented as part of the processor 502.

In some implementations, the UE 500 may include at least one transceiver 508. In some other implementations, the UE 500 may have more than one transceiver 508. The transceiver 508 may represent a wireless transceiver. The transceiver 508 may include one or more receiver chains 510, one or more transmitter chains 512, or a combination thereof.

A receiver chain 510 may be configured to receive signals (e.g., control information, data, packets) over a wireless medium. For example, the receiver chain 510 may include one or more antennas to receive a signal over the air or wireless medium. The receiver chain 510 may include at least one amplifier (e.g., a low-noise amplifier (LNA)) configured to amplify the received signal. The receiver chain 510 may include at least one demodulator configured to demodulate the receive signal and obtain the transmitted data by reversing the modulation technique applied during transmission of the signal. The receiver chain 510 may include at least one decoder for decoding the demodulated signal to receive the transmitted data.

A transmitter chain 512 may be configured to generate and transmit signals (e.g., control information, data, packets). The transmitter chain 512 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 512 may also include at least one power amplifier configured to amplify the modulated signal to an appropriate power level suitable for transmission over the wireless medium. The transmitter chain 512 may also include one or more antennas for transmitting the amplified signal into the air or wireless medium.

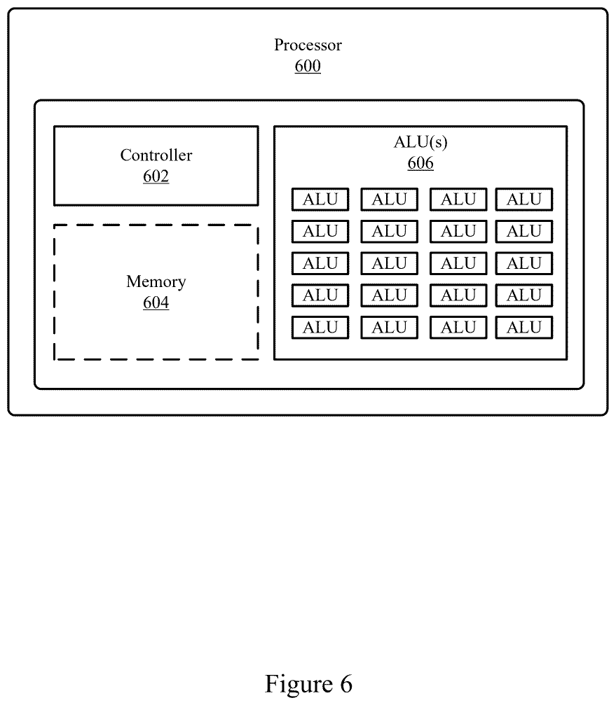

FIG. 6 illustrates an example of a processor 600 in accordance with aspects of the present disclosure. The processor 600 may be an example of a processor configured to perform various operations in accordance with examples as described herein. The processor 600 may include a controller 602 configured to perform various operations in accordance with examples as described herein. The processor 600 may optionally include at least one memory 604, which may be, for example, an L1/L2/L3 cache. Additionally, or alternatively, the processor 600 may optionally include one or more arithmetic-logic units (ALUs) 606. One or more of these components may be in electronic communication or otherwise coupled (e.g., operatively, communicatively, functionally, electronically, electrically) via one or more interfaces (e.g., buses).

The processor 600 may be a processor chipset and include a protocol stack (e.g., a software stack) executed by the processor chipset to perform various operations (e.g., receiving, obtaining, retrieving, transmitting, outputting, forwarding, storing, determining, identifying, accessing, writing, reading) in accordance with examples as described herein. The processor chipset may include one or more cores, one or more caches (e.g., memory local to or included in the processor chipset (e.g., the processor 600) or other memory (e.g., random access memory (RAM), read-only memory (ROM), dynamic RAM (DRAM), synchronous dynamic RAM (SDRAM), static RAM (SRAM), ferroelectric RAM (FeRAM), magnetic RAM (MRAM), resistive RAM (RRAM), flash memory, phase change memory (PCM), and others).

The controller 602 may be configured to manage and coordinate various operations (e.g., signaling, receiving, obtaining, retrieving, transmitting, outputting, forwarding, storing, determining, identifying, accessing, writing, reading) of the processor 600 to cause the processor 600 to support various operations in accordance with examples as described herein. For example, the controller 602 may operate as a control unit of the processor 600, generating control signals that manage the operation of various components of the processor 600. These control signals include enabling or disabling functional units, selecting data paths, initiating memory access, and coordinating timing of operations.

The controller 602 may be configured to fetch (e.g., obtain, retrieve, receive) instructions from the memory 604 and determine subsequent instruction(s) to be executed to cause the processor 600 to support various operations in accordance with examples as described herein. The controller 602 may be configured to track memory addresses of instructions associated with the memory 604. The controller 602 may be configured to decode instructions to determine the operation to be performed and the operands involved. For example, the controller 602 may be configured to interpret the instruction and determine control signals to be output to other components of the processor 600 to cause the processor 600 to support various operations in accordance with examples as described herein. Additionally, or alternatively, the controller 602 may be configured to manage flow of data within the processor 600. The controller 602 may be configured to control transfer of data between registers, ALUs 606, and other functional units of the processor 600.

The memory 604 may include one or more caches (e.g., memory local to or included in the processor 600 or other memory, such as RAM, ROM, DRAM, SDRAM, SRAM, MRAM, flash memory, etc. In some implementations, the memory 604 may reside within or on a processor chipset (e.g., local to the processor 600). In some other implementations, the memory 604 may reside external to the processor chipset (e.g., remote to the processor 600).

The memory 604 may store computer-readable, computer-executable code including instructions that, when executed by the processor 600, cause the processor 600 to perform various functions described herein. The code may be stored in a non-transitory computer-readable medium such as system memory or another type of memory. The controller 602 and/or the processor 600 may be configured to execute computer-readable instructions stored in the memory 604 to cause the processor 600 to perform various functions. For example, the processor 600 and/or the controller 602 may be coupled with or to the memory 604, the processor 600, and the controller 602, and may be configured to perform various functions described herein. In some examples, the processor 600 may include multiple processors and the memory 604 may include multiple memories. One or more of the multiple processors may be coupled with one or more of the multiple memories, which may, individually or collectively, be configured to perform various functions herein.

The one or more ALUs 606 may be configured to support various operations in accordance with examples as described herein. In some implementations, the one or more ALUs 606 may reside within or on a processor chipset (e.g., the processor 600). In some other implementations, the one or more ALUs 606 may reside external to the processor chipset (e.g., the processor 600). One or more ALUs 606 may perform one or more computations such as addition, subtraction, multiplication, and division on data. For example, one or more ALUs 606 may receive input operands and an operation code, which determines an operation to be executed. One or more ALUs 606 may be configured with a variety of logical and arithmetic circuits, including adders, subtractors, shifters, and logic gates, to process and manipulate the data according to the operation. Additionally, or alternatively, the one or more ALUs 606 may support logical operations such as AND, OR, exclusive-OR (XOR), not-OR (NOR), and not-AND (NAND), enabling the one or more ALUs 606 to handle conditional operations, comparisons, and bitwise operations.

The processor 600 may support wireless communication in accordance with examples as disclosed herein. The processor 600 may be configured to or operable to support at least one controller (e.g., the controller 602) coupled with at least one memory (e.g., the memory 604) and configured to cause the processor to receive DCI including at least one element that indicates an update to one or more parameters of a set of parameters associated with one or more paging messages, and monitor for the one or more paging messages based on the update to the one or more parameters.

Additionally, the processor 600 may be configured to support any one or combination of the at least one element includes a short messages indicator of the DCI, and where the short messages indicator indicates one or more bits of the DCI include the update to the one or more parameters. Additionally, or alternatively, the processor 600 may be configured to support the at least one element includes an element of a short messages field of the DCI, and where the element indicates one or more bits of the DCI include the update to the one or more parameters. Additionally, or alternatively, the processor 600 may be configured to support the at least one element includes a short messages indicator of the DCI, and where the short messages indicator indicates one or more bits of the DCI include scheduling information for a downlink shared channel transmission including the update to the one or more parameters. Additionally, or alternatively, the processor 600 may be configured to support receiving the downlink shared channel transmission based on the scheduling information. Additionally, or alternatively, the processor 600 may be configured to support the at least one element includes a first element of a short messages field of the DCI and a second element of the short messages field of the DCI, where the first element indicates one or more bits of the DCI include the update to the one or more parameters and the second element indicates one or more bits of a scheduled downlink shared channel transmission include the update to the one or more parameters.

Additionally, or alternatively, the processor 600 may be configured to support the at least one element further includes a short messages indicator of the DCI, and where the short messages indicator indicates that the one or more parameters are being updated. Additionally, or alternatively, the processor 600 may be configured to support receiving the scheduled downlink shared channel transmission based on the DCI. Additionally, or alternatively, the processor 600 may be configured to support receiving, prior to the DCI, signaling that indicates a set of configurations associated with paging, where a first configuration of the set of configurations includes the set of parameters associated with the one or more paging messages and where a second configuration of the set of configurations includes the update to the one or more parameters of the set of parameters associated with the one or more paging messages, and where the at least one element activates the first configuration or the second configuration. Additionally, or alternatively, the processor 600 may be configured to support the DCI is associated with a group of UEs including a UE associated with the processor 600. Additionally, or alternatively, the processor 600 may be configured to support the DCI indicates to apply the update to the one or more parameters based on a state of the processor 600, where the state of the processor 600 includes at least one of an active state, an inactive state, or an idle state.

Additionally, or alternatively, the processor 600 may be configured to support applying the update to the one or more parameters based on timing information, where the timing information includes at least one of a start of a modification period associated with the one or more paging messages, an end of a paging cycle subsequent to the DCI, a duration after reception of the DCI, or a duration relative to an SFN. Additionally, or alternatively, the processor 600 may be configured to support receiving, prior to the DCI, signaling that indicates the set of parameters associated with the one or more paging messages, and monitoring, based on the set of parameters, for the DCI, where the DCI is scrambled with a P-RNTI. Additionally, or alternatively, the processor 600 may be configured to support the one or more parameters include at least one of an updated paging cycle, a PF offset, a numerical quantity of POs within a PF, or a RAN paging in an idle PO parameter.

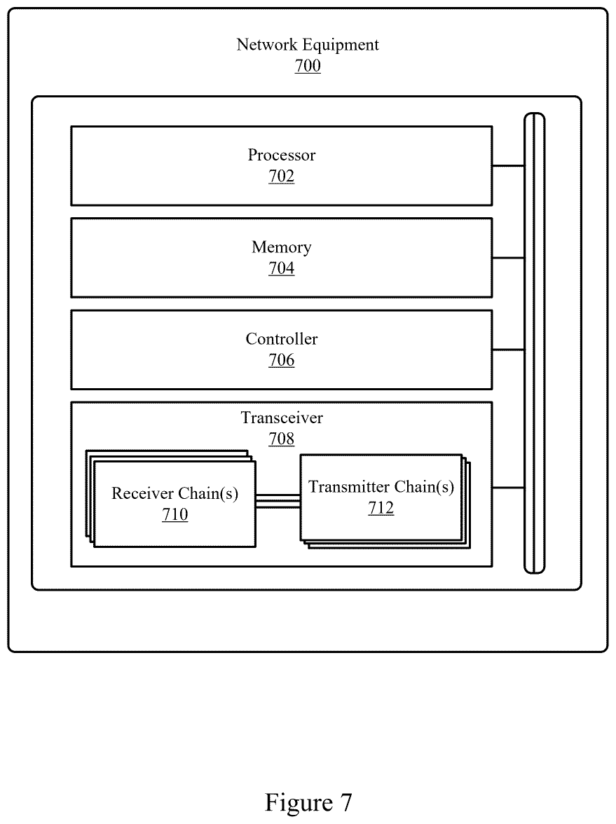

FIG. 7 illustrates an example of an NE 700 in accordance with aspects of the present disclosure. The NE 700 may include a processor 702, a memory 704, a controller 706, and a transceiver 708. The processor 702, the memory 704, the controller 706, or the transceiver 708, or various combinations thereof or various components thereof may be examples of means for performing various aspects of the present disclosure as described herein. These components may be coupled (e.g., operatively, communicatively, functionally, electronically, electrically) via one or more interfaces.

The processor 702, the memory 704, the controller 706, or the transceiver 708, or various combinations or components thereof may be implemented in hardware (e.g., circuitry). The hardware may include a processor, a digital signal processor (DSP), an application-specific integrated circuit (ASIC), or other programmable logic device, or any combination thereof configured as or otherwise supporting a means for performing the functions described in the present disclosure.

The processor 702 may include an intelligent hardware device (e.g., a general-purpose processor, a DSP, a CPU, an ASIC, an FPGA, or any combination thereof). In some implementations, the processor 702 may be configured to operate the memory 704. In some other implementations, the memory 704 may be integrated into the processor 702. The processor 702 may be configured to execute computer-readable instructions stored in the memory 704 to cause the NE 700 to perform various functions of the present disclosure.

The memory 704 may include volatile or non-volatile memory. The memory 704 may store computer-readable, computer-executable code including instructions when executed by the processor 702 cause the NE 700 to perform various functions described herein. The code may be stored in a non-transitory computer-readable medium such as the memory 704 or another type of memory. Computer-readable media includes both non-transitory computer storage media and communication media including any medium that facilitates transfer of a computer program from one place to another. A non-transitory storage medium may be any available medium that may be accessed by a general-purpose or special-purpose computer.

In some implementations, the processor 702 and the memory 704 coupled with the processor 702 may be configured to cause the NE 700 to perform one or more of the functions described herein (e.g., executing, by the processor 702, instructions stored in the memory 704). For example, the processor 702 may support wireless communication at the NE 700 in accordance with examples as disclosed herein. The NE 700 may be configured to or operable to support a means for transmitting DCI including at least one element that indicates an update to one or more parameters of a set of parameters associated with one or more paging messages, and transmitting the one or more paging messages based on the update to the one or more parameters.

Additionally, the NE 700 may be configured to or operable to support any one or combination of the at least one element includes a short messages indicator of the DCI, and where the short messages indicator indicates one or more bits of the DCI include the update to the one or more parameters. Additionally, or alternatively, the NE 700 may be configured to support the at least one element includes an element of a short messages field of the DCI, and where the element indicates one or more bits of the DCI include the update to the one or more parameters. Additionally, or alternatively, the NE 700 may be configured to support the at least one element includes a short messages indicator of the DCI, and where the short messages indicator indicates one or more bits of the DCI include scheduling information for a downlink shared channel transmission including the update to the one or more parameters. Additionally, or alternatively, the NE 700 may be configured to support transmitting the downlink shared channel transmission based on the scheduling information.

Additionally, or alternatively, the NE 700 may be configured to support the at least one element includes a first element of a short messages field of the DCI and a second element of the short messages field of the DCI, where the first element indicates one or more bits of the DCI include the update to the one or more parameters and the second element indicates one or more bits of a scheduled downlink shared channel transmission include the update to the one or more parameters. Additionally, or alternatively, the NE 700 may be configured to support the at least one element further includes a short messages indicator of the DCI, and where the short messages indicator indicates that the one or more parameters are being updated. Additionally, or alternatively, the NE 700 may be configured to support transmitting the scheduled downlink shared channel transmission based on the DCI. Additionally, or alternatively, the NE 700 may be configured to support transmitting, prior to the DCI, signaling that indicates a set of configurations associated with paging, where a first configuration of the set of configurations includes the set of parameters associated with the one or more paging messages and where a second configuration of the set of configurations includes the update to the one or more parameters of the set of parameters associated with the one or more paging messages, and where the at least one element activates the first configuration or the second configuration.

Additionally, or alternatively, the NE 700 may be configured to support transmitting, after the DCI, one or more SIBs, where the one or more SIBs include the update to the one or more parameters. Additionally, or alternatively, the NE 700 may be configured to support transmitting the DCI to a group of UEs. Additionally, or alternatively, the NE 700 may be configured to support the DCI indicates to apply the update to the one or more parameters based on a state of a UE, where the state of the UE includes at least one of an active state, an inactive state, or an idle state. Additionally, or alternatively, the NE 700 may be configured to support transmitting, prior to the DCI, signaling that indicates the set of parameters associated with the one or more paging messages, where the DCI is transmitted based on the set of parameters, and where the DCI is scrambled with a P-RNTI. Additionally, or alternatively, the NE 700 may be configured to support the one or more parameters include at least one of an updated paging cycle, a PF offset, a numerical quantity of POs within a PF, or a RAN paging in an idle PO parameter.

Additionally, or alternatively, the NE 700 may support at least one memory (e.g., the memory 704) and at least one processor (e.g., the processor 702) coupled with the at least one memory and configured to cause the NE to transmit DCI including at least one element that indicates an update to one or more parameters of a set of parameters associated with one or more paging messages, and transmit the one or more paging messages based on the update to the one or more parameters.

Additionally, the NE 700 may be configured to support any one or combination of the at least one element includes a short messages indicator of the DCI, and where the short messages indicator indicates one or more bits of the DCI include the update to the one or more parameters. Additionally, or alternatively, the NE 700 may be configured to support the at least one element includes an element of a short messages field of the DCI, and where the element indicates one or more bits of the DCI include the update to the one or more parameters. Additionally, or alternatively, the NE 700 may be configured to support the at least one element includes a short messages indicator of the DCI, and where the short messages indicator indicates one or more bits of the DCI include scheduling information for a downlink shared channel transmission including the update to the one or more parameters. Additionally, or alternatively, the NE 700 may be configured to support transmitting the downlink shared channel transmission based on the scheduling information.

Additionally, or alternatively, the NE 700 may be configured to support the at least one element includes a first element of a short messages field of the DCI and a second element of the short messages field of the DCI, where the first element indicates one or more bits of the DCI include the update to the one or more parameters and the second element indicates one or more bits of a scheduled downlink shared channel transmission include the update to the one or more parameters. Additionally, or alternatively, the NE 700 may be configured to support the at least one element further includes a short messages indicator of the DCI, and where the short messages indicator indicates that the one or more parameters are being updated. Additionally, or alternatively, the NE 700 may be configured to support transmitting the scheduled downlink shared channel transmission based on the DCI. Additionally, or alternatively, the NE 700 may be configured to support transmitting, prior to the DCI, signaling that indicates a set of configurations associated with paging, where a first configuration of the set of configurations includes the set of parameters associated with the one or more paging messages and where a second configuration of the set of configurations includes the update to the one or more parameters of the set of parameters associated with the one or more paging messages, and where the at least one element activates the first configuration or the second configuration.

Additionally, or alternatively, the NE 700 may be configured to support transmitting, after the DCI, one or more SIBs, where the one or more SIBs include the update to the one or more parameters. Additionally, or alternatively, the NE 700 may be configured to support transmitting the DCI to a group of UEs. Additionally, or alternatively, the NE 700 may be configured to support the DCI indicates to apply the update to the one or more parameters based on a state of a UE, where the state of the UE includes at least one of an active state, an inactive state, or an idle state. Additionally, or alternatively, the NE 700 may be configured to support transmitting, prior to the DCI, signaling that indicates the set of parameters associated with the one or more paging messages, where the DCI is transmitted based on the set of parameters, and where the DCI is scrambled with a P-RNTI. Additionally, or alternatively, the NE 700 may be configured to support the one or more parameters include at least one of an updated paging cycle, a PF offset, a numerical quantity of POs within a PF, or a RAN paging in an idle PO parameter.

The controller 706 may manage input and output signals for the NE 700. The controller 706 may also manage peripherals not integrated into the NE 700. In some implementations, the controller 706 may utilize an operating system such as iOS®, ANDROID®, WINDOWS®, or other operating systems. In some implementations, the controller 706 may be implemented as part of the processor 702.

In some implementations, the NE 700 may include at least one transceiver 708. In some other implementations, the NE 700 may have more than one transceiver 708. The transceiver 708 may represent a wireless transceiver. The transceiver 708 may include one or more receiver chains 710, one or more transmitter chains 712, or a combination thereof.

A receiver chain 710 may be configured to receive signals (e.g., control information, data, packets) over a wireless medium. For example, the receiver chain 710 may include one or more antennas to receive a signal over the air or wireless medium. The receiver chain 710 may include at least one amplifier (e.g., a low-noise amplifier (LNA)) configured to amplify the received signal. The receiver chain 710 may include at least one demodulator configured to demodulate the receive signal and obtain the transmitted data by reversing the modulation technique applied during transmission of the signal. The receiver chain 710 may include at least one decoder for decoding the demodulated signal to receive the transmitted data.

A transmitter chain 712 may be configured to generate and transmit signals (e.g., control information, data, packets). The transmitter chain 712 may include at least one modulator for modulating data onto a carrier signal, preparing the signal for transmission over a wireless medium. The at least one modulator may be configured to support one or more techniques such as amplitude modulation (AM), frequency modulation (FM), or digital modulation schemes like phase-shift keying (PSK) or quadrature amplitude modulation (QAM). The transmitter chain 712 may also include at least one power amplifier configured to amplify the modulated signal to an appropriate power level suitable for transmission over the wireless medium. The transmitter chain 712 may also include one or more antennas for transmitting the amplified signal into the air or wireless medium.

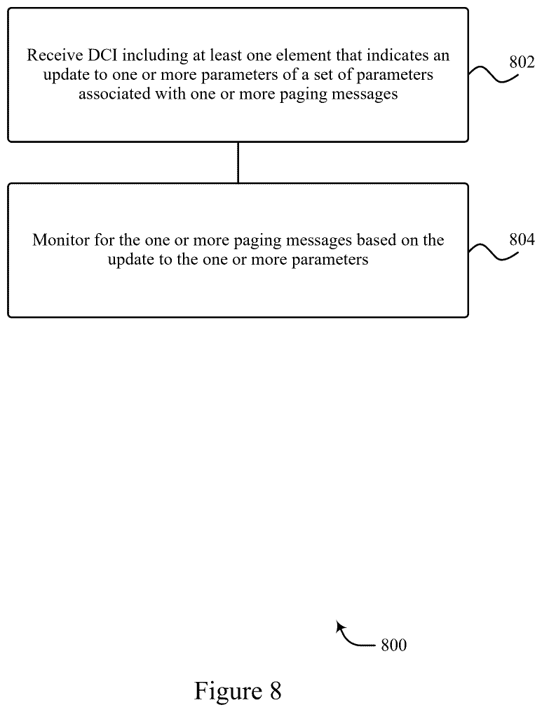

FIG. 8 illustrates a flowchart of a method 800 in accordance with aspects of the present disclosure. The operations of the method may be implemented by a UE as described herein. In some implementations, the UE may execute a set of instructions to control the function elements of the UE to perform the described functions. It should be noted that the method described herein describes a possible implementation, and that the operations and the steps may be rearranged or otherwise modified and that other implementations are possible.

At 802, the method may include receiving DCI including at least one element that indicates an update to one or more parameters of a set of parameters associated with one or more paging messages. The operations of 802 may be performed in accordance with examples as described herein. In some implementations, aspects of the operations of 802 may be performed by a UE as described with reference to FIG. 5.

At 804, the method may include monitoring for the one or more paging messages based on the update to the one or more parameters. The operations of 804 may be performed in accordance with examples as described herein. In some implementations, aspects of the operations of 804 may be performed by a UE as described with reference to FIG. 5.

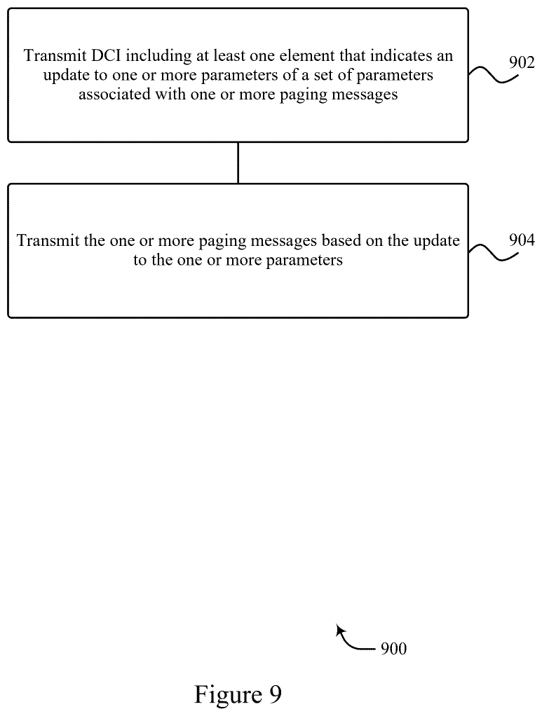

FIG. 9 illustrates a flowchart of a method 900 in accordance with aspects of the present disclosure. The operations of the method may be implemented by an NE as described herein. In some implementations, the NE may execute a set of instructions to control the function elements of the NE to perform the described functions. It should be noted that the method described herein describes a possible implementation, and that the operations and the steps may be rearranged or otherwise modified and that other implementations are possible.

At 902, the method may include transmitting DCI including at least one element that indicates an update to one or more parameters of a set of parameters associated with one or more paging messages. The operations of 902 may be performed in accordance with examples as described herein. In some implementations, aspects of the operations of 902 may be performed by an NE as described with reference to FIG. 7.

At 904, the method may include transmitting the one or more paging messages based on the update to the one or more parameter. The operations of 904 may be performed in accordance with examples as described herein. In some implementations, aspects of the operations of 904 may be performed by an NE as described with reference to FIG. 7.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A user equipment (UE) for wireless communication, comprising:
at least one memory; and
at least one processor coupled with the at least one memory and configured to cause the UE to:
receive downlink control information (DCI) comprising at least one element that indicates an update to one or more parameters of a plurality of parameters associated with one or more paging messages; and
monitor for the one or more paging messages based at least in part on the update to the one or more parameters.

2. The UE of claim 1, wherein the at least one element comprises a short messages indicator of the DCI, and wherein the short messages indicator indicates one or more bits of the DCI comprise the update to the one or more parameters.

3. The UE of claim 1, wherein the at least one element comprises an element of a short messages field of the DCI, and wherein the element indicates one or more bits of the DCI comprise the update to the one or more parameters.

4. The UE of claim 1, wherein the at least one element comprises a short messages indicator of the DCI, and wherein the short messages indicator indicates one or more bits of the DCI comprise scheduling information for a downlink shared channel transmission comprising the update to the one or more parameters.

5. The UE of claim 1, wherein the at least one element comprises a first element of a short messages field of the DCI and a second element of the short messages field of the DCI, wherein the first element indicates one or more bits of the DCI comprise the update to the one or more parameters and the second element indicates one or more bits of a scheduled downlink shared channel transmission comprise the update to the one or more parameters.

6. The UE of claim 5, wherein the at least one element further comprises a short messages indicator of the DCI, and wherein the short messages indicator indicates that the one or more parameters are being updated.

7. The UE of claim 1, wherein the at least one processor is further configured to cause the UE to receive, prior to the DCI, signaling that indicates a plurality of configurations associated with paging, wherein a first configuration of the plurality of configurations comprises the plurality of parameters associated with the one or more paging messages and wherein a second configuration of the plurality of configurations comprises the update to the one or more parameters of the plurality of parameters associated with the one or more paging messages, and wherein the at least one element activates the first configuration or the second configuration.

8. The UE of claim 1, wherein the DCI is associated with a group of UEs comprising the UE.

9. The UE of claim 1, wherein the DCI indicates to apply the update to the one or more parameters based at least in part on a state of the UE, wherein the state of the UE comprises at least one of an active state, an inactive state, or an idle state.

10. The UE of claim 1, wherein to monitor for the one or more paging messages, the at least one processor is configured to cause the UE to apply the update to the one or more parameters based at least in part on timing information, wherein the timing information comprises at least one of a start of a modification period associated with the one or more paging messages, an end of a paging cycle subsequent to the DCI, a duration after reception of the DCI, or a duration relative to a system frame number (SFN).

11. The UE of claim 1, wherein to receive the DCI, the at least one processor is configured to cause the UE to:
receive, prior to the DCI, signaling that indicates the plurality of parameters associated with the one or more paging messages; and
monitor, based at least in part on the plurality of parameters, for the DCI, wherein the DCI is scrambled with a paging-radio network temporary identifier (P-RNTI).

12. The UE of claim 1, wherein the one or more parameters comprise at least one of an updated paging cycle, a paging frame (PF) offset, a numerical quantity of paging occasions (POs) within a PF, or a radio access network (RAN) paging in an idle PO parameter.

13. A processor for wireless communication, comprising:
at least one controller coupled with at least one memory and configured to cause the processor to:
receive downlink control information (DCI) comprising at least one element that indicates an update to one or more parameters of a plurality of parameters associated with one or more paging messages; and
monitor for the one or more paging messages based at least in part on the update to the one or more parameters.

14. A method performed by a user equipment (UE), the method comprising:
receiving downlink control information (DCI) comprising at least one element that indicates an update to one or more parameters of a plurality of parameters associated with one or more paging messages; and
monitoring for the one or more paging messages based at least in part on the update to the one or more parameters.

15. A network equipment (NE) for wireless communication, comprising:
at least one memory; and
at least one processor coupled with the at least one memory and configured to cause the NE to:
transmit downlink control information (DCI) comprising at least one element that indicates an update to one or more parameters of a plurality of parameters associated with one or more paging messages; and
transmit the one or more paging messages based at least in part on the update to the one or more parameters.

16. The NE of claim 15, wherein the at least one element comprises a short messages indicator of the DCI, and wherein the short messages indicator indicates one or more bits of the DCI comprise the update to the one or more parameters.

17. The NE of claim 15, wherein the at least one element comprises an element of a short messages field of the DCI, and wherein the element indicates one or more bits of the DCI comprise the update to the one or more parameters.

18. The NE of claim 15, wherein the at least one element comprises a short messages indicator of the DCI, and wherein the short messages indicator indicates one or more bits of the DCI comprise scheduling information for a downlink shared channel transmission comprising the update to the one or more parameters.

19. The NE of claim 15, wherein the at least one element comprises a first element of a short messages field of the DCI and a second element of the short messages field of the DCI, wherein the first element indicates one or more bits of the DCI comprise the update to the one or more parameters and the second element indicates one or more bits of a scheduled downlink shared channel transmission comprise the update to the one or more parameters.

20. The NE of claim 15, wherein the at least one processor is configured to cause the NE to transmit, after the DCI, one or more system information blocks (SIBs), wherein the one or more SIBs comprise the update to the one or more parameters.
